(19) United States
(12) Patent Application Publication
(10) Pub. No.: US 2024/0375645 A1
(43) Pub. Date: Nov. 14, 2024

(54) OVERTAKE DECISION BASED ON OTHER VEHICLE BEHAVIOR

(71) Applicant: Volvo Car Corporation, Göteborg (SE)

(72) Inventors: Oswaldo Perez Barrera, Gothenburg (SE); Anders Lennartsson, Gothenburg (SE)

(21) Appl. No.: 18/314,609

(22) Filed: May 9, 2023

(51) Int. Cl. B60W 30/095; B60W 30/18; B60W 60/00

(52) U.S. Cl. CPC B60W 30/0956; B60W 30/18163; B60W 60/0027; B60W 2552/05; B60W 2554/20; B60W 2554/402; B60W 2554/4041; B60W 2554/4044; B60W 2554/4045; B60W 2554/802; B60W 2555/60; B60W 2556/65

(57) ABSTRACT

An overtake decision (e.g., for a vehicle) based on behavior of another vehicle (e.g., using a computerized tool) is enabled. For example, a method can comprise: based upon a condition applicable to a second vehicle, other than a first vehicle, determining, by a system comprising a processor, a predicted movement of the second vehicle, and based on the predicted movement being determined to satisfy a defined overtake condition, initiating, by the system, an overtake action, applicable to the first vehicle, to overtake the second vehicle.

### TECHNICAL FIELD

The disclosed subject matter relates to vehicles (e.g., transportation vehicles) and, more particularly, to an overtake decision (e.g., for a vehicle) based on a behavior of another vehicle.

### BACKGROUND

Vehicles can stop on a road for one or more of a variety of reasons, for instance, due to a breakdown, to pick-up/drop-off occupants, as a result of a rear-end collision, as a result of a flat tire, as a result of reckless parking, etc. Stopping on a road can lead to traffic buildup, for instance, if a vehicle stops in a lane and blocks the flow of traffic. Some stops can be brief (e.g., to allow a passenger to egress), however, some stops can last for an extended period of time (e.g., for a flat tire). Conventional vehicles, including conventional autonomous vehicles, are unaware of how long such a stop will last, and thus lack insight into whether the autonomous vehicle should pass a stopped vehicle, or wait for the stopped vehicle to move.

The above-described background relating to an overtake decision (e.g., for a vehicle) based on behavior of another vehicle is merely intended to provide a contextual overview of some current issues and is not intended to be exhaustive. Other contextual information may become further apparent upon review of the following detailed description.

### SUMMARY

The following presents a summary to provide a basic understanding of one or more embodiments of the invention. This summary is not intended to identify key or critical elements, or delineate any scope of the particular embodiments or any scope of the claims. Its sole purpose is to present concepts in a simplified form as a prelude to the more detailed description that is presented later. In one or more embodiments described herein, systems, devices, computer-implemented methods, apparatuses and/or computer program products that facilitate vehicle passenger space identification and/or contact mitigation are described.

As alluded to above, autonomous vehicle systems can be improved in various ways, and various embodiments are described herein to this end and/or other ends.

According to an embodiment, a system can comprise a memory that stores computer executable components, and a processor that executes the computer executable components stored in the memory, wherein the computer executable components can comprise: a vehicular behavior component that, based upon a condition applicable to a second vehicle, other than a first vehicle, determines a predicted movement of the second vehicle, and an overtake determination component that, based on the predicted movement being determined to satisfy a defined overtake condition, initiates an overtake action, applicable to the first vehicle, to overtake the second vehicle.

According to another embodiment, a non-transitory machine-readable medium can comprise executable instructions that, when executed by a processor, facilitate performance of operations, comprising: based upon a condition applicable to a second vehicle, other than a first vehicle, determining a predicted movement of the second vehicle, and based on the predicted movement being determined to satisfy a defined overtake condition, initiating an overtake action, applicable to the first vehicle, to overtake the second vehicle.

According to yet another embodiment, a method can comprise: based upon a condition applicable to a second vehicle, other than a first vehicle, determining, by a system comprising a processor, a predicted movement of the second vehicle, and based on the predicted movement being determined to satisfy a defined overtake condition, initiating, by the system, an overtake action, applicable to the first vehicle, to overtake the second vehicle.

### BRIEF DESCRIPTION OF DRAWINGS

FIG. 1 illustrates a block diagram of an exemplary system in accordance with one or more embodiments described herein.

FIG. 2 illustrates a block diagram of example, non-limiting computer executable components in accordance with one or more embodiments described herein.

FIG. 3 illustrates a block diagram of example, non-limiting vehicle electronic systems/devices in accordance with one or more embodiments described herein.

FIG. 4 illustrates a block diagram of example, non-limiting external devices in accordance with one or more embodiments described herein.

FIG. 5 illustrates an example, non-limiting scenario in accordance with one or more embodiments described herein.

FIG. 6 illustrates an example, non-limiting vehicle database in accordance with one or more embodiments described herein.

FIG. 7 illustrates an example, non-limiting scenario in accordance with one or more embodiments described herein.

FIG. 8 illustrates an example, non-limiting scenario in accordance with one or more embodiments described herein.

FIG. 9 illustrates an example, non-limiting scenario in accordance with one or more embodiments described herein.

FIG. 10 illustrates an example, non-limiting scenario in accordance with one or more embodiments described herein.

FIG. 11 illustrates an example, non-limiting scenario in accordance with one or more embodiments described herein.

FIG. 12 illustrates an example, non-limiting scenario in accordance with one or more embodiments described herein.

FIG. 13 illustrates an example, non-limiting scenario in accordance with one or more embodiments described herein.

FIG. 14 illustrates an example, non-limiting scenario in accordance with one or more embodiments described herein.

FIG. 15 illustrates an example, non-limiting scenario in accordance with one or more embodiments described herein.

FIG. 16 illustrates an example, non-limiting scenario in accordance with one or more embodiments described herein.

FIG. 17 illustrates an example, non-limiting scenario in accordance with one or more embodiments described herein.

FIG. 18 illustrates a block flow diagram for a process associated with an overtake decision (e.g., for a vehicle) based on behavior of another vehicle in accordance with one or more embodiments described herein.

FIG. 19 is an example, non-limiting computing environment in which one or more embodiments described herein can be implemented.

FIG. 20 is an example, non-limiting networking environment in which one or more embodiments described herein can be implemented.

### DETAILED DESCRIPTION

The following detailed description is merely illustrative and is not intended to limit embodiments and/or application or uses of embodiments. Furthermore, there is no intention to be bound by any expressed or implied information presented in the preceding Background or Summary sections, or in the Detailed Description section.

One or more embodiments are now described with reference to the drawings, wherein like referenced numerals are used to refer to like elements throughout. In the following description, for purposes of explanation, numerous specific details are set forth in order to provide a more thorough understanding of the one or more embodiments. It is evident, however, in various cases, that the one or more embodiments can be practiced without these specific details.

It will be understood that when an element is referred to as being “coupled” to another element, it can describe one or more different types of coupling including, but not limited to, chemical coupling, communicative coupling, capacitive coupling, electrical coupling, electromagnetic coupling, inductive coupling, operative coupling, conductive coupling, acoustic coupling, ultrasound coupling, optical coupling, physical coupling, thermal coupling, and/or another type of coupling. As referenced herein, an “entity” can comprise a human, a client, a user, a computing device, a software application, an agent, a machine learning model, an artificial intelligence, and/or another entity. It should be appreciated that such an entity can facilitate implementation of the subject disclosure in accordance with one or more embodiments the described herein.

The computer processing systems, computer-implemented methods, apparatus and/or computer program products described herein employ hardware and/or software to solve problems that are highly technical in nature (e.g., identify vehicle passenger space and/or mitigate contact), that are not abstract and cannot be performed as a set of mental acts by a human.

Various embodiments described herein enable identification (e.g., by a first vehicle herein) when a second vehicle stops in front the first vehicle and, depending on certain detections and/or determinations by the first vehicle (e.g., such as if the second vehicle is a school bus in a bus stop, or if a driver gets out of the car), the first vehicle can decide whether or not to overtake the second vehicle. With a series of steps and conditions, the first vehicle can infer whether the second vehicle stops under an expected condition or an unexpected condition. Some conditions can be based on detection the type of second vehicle (e.g., family car vs school bus), whether the doors of the second vehicle are open or closed and/or a pedestrian is detected approaching or moving away from the vehicle (e.g., ingress or egress). If the first vehicle determines that the situation is unexpected (e.g., abnormal), such as family car stopping following by a driver exiting the family car, or if the first vehicle determines that a threshold amount of time is predicted to elapse before a stopped vehicle (e.g., second vehicle) moves again (e.g., a school bus picking up several kids), the first vehicle can determine overtake the second vehicle. However, if the situation is determined to be expected (e.g., normal), such as a taxi picking up a costumer), then the first vehicle can be configured to wait for the second vehicle to move again. Depending on the scenario, such an overtake action decision herein can be made (e.g., by the first vehicle) before the first vehicle unnecessarily applies its brakes as a result of approaching the second vehicle.

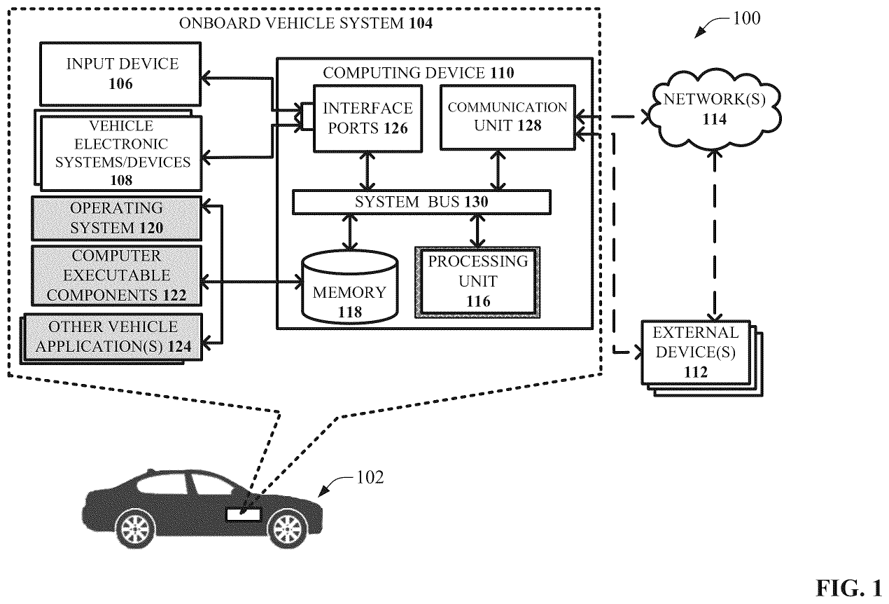

Turning now to FIG. 1, there is illustrated an example, non-limiting system 100 in accordance with one or more embodiments herein. System 100 can comprise a computerized tool, which can be configured to perform various operations relating to an overtake decision (e.g., for a vehicle) based on behavior of another vehicle. In accordance with various exemplary embodiments, system 100 can be deployed on or within a vehicle 102, (e.g., an automobile, as shown in FIG. 1). Although FIG. 1 depicts the vehicle 102 as an automobile, the architecture of the system 100 is not so limited. For instance, the system 100 described herein can be implemented with a variety of types of vehicles 102. Example vehicles 102 that can incorporate the exemplary system 100 can include, but are not limited to: automobiles (e.g., autonomous vehicles or semi-autonomous vehicles), airplanes, trains, motorcycles, carts, trucks, semi-trucks, buses, boats, recreational vehicles, helicopters, jets, electric scooters, electric bicycles, a combination thereof, and/or the like. It is additionally noted that the system 100 can be implemented in a variety of types of automobiles, such as battery electric vehicles, hybrid vehicles, plug-in hybrid vehicles, internal combustion engine vehicles, or other suitable types of vehicles.

As shown in FIG. 1, the system 100 can comprise one or more onboard vehicle systems 104, which can comprise one or more input devices 106, one or more other vehicle electronic systems and/or devices 108, and/or one or more computing devices 110. Additionally, the system 100 can comprise one or more external devices 112 that can be communicatively and/or operatively coupled to the one or more computing devices 110 of the one or more onboard vehicle systems 104 either via one or more networks 114 and/or a direct electrical connection (e.g., as shown in FIG. 1). In various embodiments, one or more of the onboard vehicle system 104, input devices 106, vehicle electronic systems and/or devices 108, computing devices 110, external devices 112, and/or networks 114 can be communicatively or operably coupled (e.g., over a bus or wireless network) to one another to perform one or more functions of the system 100.

The one or more input devices 106 can display one or more interactive graphic entity interfaces (“GUIs”) that facilitate accessing and/or controlling various functions and/or application of the vehicle 102. The one or more input devices 106 can display one or more interactive GUIs that facilitate accessing and/or controlling various functions and/or applications. The one or more input devices 106 can comprise one or more computerized devices, which can include, but are not limited to: personal computers, desktop computers, laptop computers, cellular telephones (e.g., smartphones or mobile devices), computerized tablets (e.g., comprising a processor), smart watches, keyboards, touchscreens, mice, a combination thereof, and/or the like. An entity or user of the system 100 can utilize the one or more input devices 106 to input data into the system 100. Additionally, the one or more input devices 106 can comprise one or more displays that can present one or more outputs generated by the system 100 to an entity. For example, the one or more displays can include, but are not limited to: cathode tube display (“CRT”), light-emitting diode display (“LED”), electroluminescent display (“ELD”), plasma display panel (“PDP”), liquid crystal display (“LCD”), organic light-emitting diode display (“OLED”), a combination thereof, and/or the like.

For example, the one or more input devices 106 can comprise a touchscreen that can present one or more graphical touch controls that can respectively correspond to a control for a function of the vehicle 102, an application, a function of the application, interactive data, a hyperlink to data, and the like, wherein selection and/or interaction with the graphical touch control via touch activates the corresponding functionality. For instance, one or more GUIs displayed on the one or more input devices 106 can include selectable graphical elements, such as buttons or bars corresponding to a vehicle navigation application, a media application, a phone application, a back-up camera function, a car settings function, a parking assist function, and/or the like. In some implementations, selection of a button or bar corresponding to an application or function can result in the generation of a new window or GUI comprising additional selectable icons or widgets associated with the selected application. For example, selection of one or more selectable options herein can result in generation of a new GUI or window that includes additional buttons or widgets with one or more selectable options. The type and appearance of the controls can vary. For example, the graphical touch controls can include icons, symbols, widgets, windows, tabs, text, images, a combination thereof, and/or the like.

The one or more input devices 106 can comprise suitable hardware that registers input events in response to touch (e.g., by a finger, stylus, gloved hand, pen, etc.). In some implementations, the one or more input devices 106 can detect the position of an object (e.g., by a finger, stylus, gloved hand, pen, etc.) over the one or more input devices 106 within close proximity (e.g., a few centimeters) to touchscreen without the object touching the screen. As used herein, unless otherwise specified, reference to “on the touchscreen” refers to contact between an object (e.g., an entity's finger) and the one or more input devices 106 while reference to “over the touchscreen” refers to positioning of an object within close proximity to the touchscreen (e.g., a defined distance away from the touchscreen) yet not contacting the touchscreen.

The type of the input devices 106 can vary and can include, but is not limited to: a resistive touchscreen, a surface capacitive touchscreen, a projected capacitive touchscreen, a surface acoustic wave touchscreen, and an infrared touchscreen. In various embodiments, the one or more input devices 106 can be positioned on the dashboard of the vehicle 102, such as on or within the center stack or center console of the dashboard. However, the position of the one or more input devices 106 within the vehicle 102 can vary.

The one or more other vehicle electronic systems and/or devices 108 can include one or more additional devices and/or systems (e.g., in addition to the one or more input devices 106 and/or computing devices 110) of the vehicle 102 that can be controlled based at least in part on commands issued by the one or more computing devices 110 (e.g., via one or more processing units 116) and/or commands issued by the one or more external devices 112 communicatively coupled thereto. For example, the one or more other vehicle electronic systems and/or devices 108 can comprise: seat motors, seatbelt system(s), airbag system(s), display(s), infotainment system(s), speaker(s), a media system (e.g., audio and/or video), a back-up camera system, a heating, ventilation, and air conditioning (“HVAC”) system, a lighting system, a cruise control system, a power locking system, a navigation system, an autonomous driving system, a vehicle sensor system, telecommunications system, a combination thereof, and/or the like. Other example other vehicle electronic systems and/or devices 108 can comprise one or more sensors, which can comprise distance sensors, seats, seat position sensor(s), collision sensor(s), odometers, altimeters, speedometers, accelerometers, engine features and/or components, fuel meters, flow meters, cameras (e.g., digital cameras, heat cameras, infrared cameras, and/or the like), lasers, radar systems, lidar systems, microphones, vibration meters, moisture sensors, thermometers, seatbelt sensors, wheel speed sensors, a combination thereof, and/or the like. For instance, a speedometer of the vehicle 102 can detect the vehicle 102's traveling speed. Further, the one or more sensors can detect and/or measure one or more conditions outside the vehicle 102, such as: whether the vehicle 102 is traveling through a rainy environment, whether the vehicle 102 is traveling through winter conditions (e.g., snowy and/or icy conditions), whether the vehicle 102 is traveling through very hot conditions (e.g., desert conditions), and/or the like. Example navigational information can include, but is not limited to: the destination of the vehicle 102, the position of the vehicle 102, the type of vehicle 102, the speed of the vehicle 102, environmental conditions surrounding the vehicle 102, the planned route of the vehicle 102, traffic conditions expected to be encountered by the vehicle 102, operational status of the vehicle 102, a combination thereof, and/or the like.

The one or more computing devices 110 can facilitate executing and controlling one or more operations of the vehicle 102, including one or more operations of the one or more input devices 106, and the one or more other vehicle electronic systems/devices 108 using machine-executable instructions. In this regard, embodiments of system 100 and other systems described herein can include one or more machine-executable components embodied within one or more machines (e.g., embodied in one or more computer readable storage media associated with one or more machines, such as computing device 110). Such components, when executed by the one or more machines (e.g., processors, computers, virtual machines, etc.) can cause the one or more machines to perform the operations described.

For example, the one or more computing devices 110 can include or be operatively coupled to at least one memory 118 and/or at least one processing unit 116. The one or more processing units 116 can be any of various available processors. For example, dual microprocessors and other multiprocessor architectures also can be employed as the processing unit 116. In various embodiments, the at least one memory 118 can store software instructions embodied as functions and/or applications that when executed by the at least one processing unit 116, facilitate performance of operations defined by the software instruction. In the embodiment shown, these software instructions can include one or more operating system 120, one or more computer executable components 122, and/or one or more other vehicle applications 124. For example, the one or more operating systems 120 can act to control and/or allocate resources of the one or more computing devices 110. It is to be appreciated that the claimed subject matter can be implemented with various operating systems or combinations of operating systems.

The one or more computer executable components 122 and/or the one or more other vehicle applications 124 can take advantage of the management of resources by the one or more operating systems 120 through program modules and program data also stored in the one or more memories 118. The one or more computer executable components 122 can provide various features and/or functionalities that can facilitate an overtake decision (e.g., for a vehicle) based on behavior of another vehicle herein. Example, other vehicle applications 124 can include, but are not limited to: a navigation application, a media player application, a phone application, a vehicle settings application, a parking assistance application, an emergency roadside assistance application, a combination thereof, and/or the like. The features and functionalities of the one or more computer executable components 122 are discussed in greater detail infra.

The one or more computing devices 110 can further include one or more interface ports 126, one or more communication units 128, and a system bus 130 that can communicatively couple the various features of the one or more computing devices 110 (e.g., the one or more interface ports 126, the one or more communication units 128, the one or more memories 118, and/or the one or more processing units 116). The one or more interface ports 126 can connect the one or more input devices 106 (and other potential devices) and the one or more other vehicle electronic systems/devices 108 to the one or more computing devices 110. For example, the one or more interface ports 126 can include, a serial port, a parallel port, a game port, a universal serial bus (“USB”) and the like.

The one or more communication units 128 can include suitable hardware and/or software that can facilitate connecting one or more external devices 112 to the one or more computing devices 110 (e.g., via a wireless connection and/or a wired connection). For example, the one or more communication units 128 can be operatively coupled to the one or more external devices 112 via one or more networks 114. The one or more networks 114 can include wired and/or wireless networks, including but not limited to, a personal area network (“PAN”), a local area network (“LAN”), a cellular network, a wide area network (“WAN”, e.g., the Internet), and the like. For example, the one or more external devices 112 can communicate with the one or more computing devices 110 (and vice versa) using virtually any desired wired or wireless technology, including but not limited to: wireless fidelity (“Wi-Fi”), global system for mobile communications (“GSM”), universal mobile telecommunications system (“UMTS”), worldwide interoperability for microwave access (“WiMAX”), enhanced general packet radio service (enhanced “GPRS”), fifth generation (“5G”) communication system, sixth generation (“6G”) communication system, third generation partnership project (“3GPP”) long term evolution (“LTE”), third generation partnership project 2 (“3GPP2”) ultra-mobile broadband (“UMB”), high speed packet access (“HSPA”), Zigbee and other 802.XX wireless technologies and/or legacy telecommunication technologies, near field communication (“NFC”) technology, BLUETOOTH®, Session Initiation Protocol (“SIP”), ZIGBEE®, RF4CE protocol, WirelessHART protocol, 6LoWPAN (IPv6 over Low power Wireless Area Networks), Z-Wave, an ANT, an ultra-wideband (“UWB”) standard protocol, and/or other proprietary and non-proprietary communication protocols. In this regard, the one or more communication units 128 can include software, hardware, or a combination of software and hardware that is configured to facilitate wired and/or wireless communication between the one or more computing devices 110 and the one or more external devices 112. While the one or more communication units 128 are shown for illustrative clarity as a separate unit that is not stored within memory 118, it is to be appreciated that one or more (software) components of the communication unit can be stored in memory 118 and include computer executable components.

The one or more external devices 112 can include any suitable computing device comprising a display and input device (e.g., a touchscreen) that can communicate with the one or more computing devices 110 comprised within the onboard vehicle system 104 and interface with the one or more computer executable components 122 (e.g., using a suitable application program interface (“API”)). For example, the one or more external devices 112 can include, but are not limited to: a mobile phone, a smartphone, a tablet, a personal computer (“PC”), a digital assistant (“PDA”), a heads-up display (“HUD”), virtual reality (“VR”) headset, an augmented reality (“AR”) headset, or another type of wearable computing device, a desktop computer, a laptop computer, a computer tablet, a combination thereof, and the like.

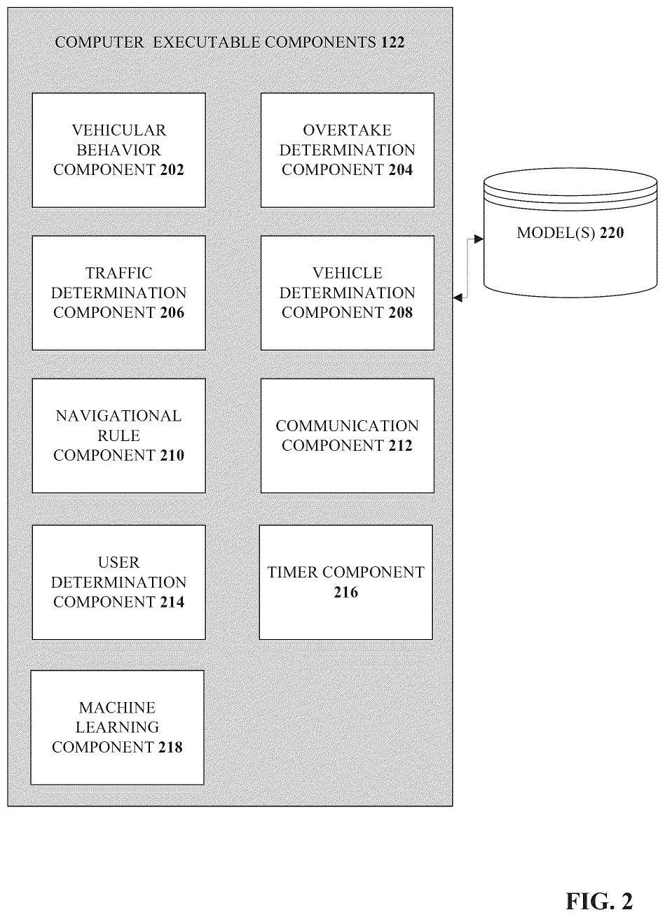

FIG. 2 illustrates a block diagram of example, non-limiting computer executable components 122 that can facilitate an overtake decision (e.g., for a vehicle) based on behavior of another vehicle in accordance with one or more embodiments described herein. Repetitive description of like elements employed in other embodiments described herein is omitted for sake of brevity. As shown in FIG. 2, the one or more computer executable components 122 can comprise vehicular behavior component 202, overtake determination component 204, traffic determination component 206, vehicle determination component 208, navigational rule component 210, communication component 212, user determination component 214, timer component 216, and/or machine learning component 218. In various embodiments, the computer executable components can be communicatively coupled to and/or can further comprise machine learning based model(s) 220, which can be stored in memory 118.

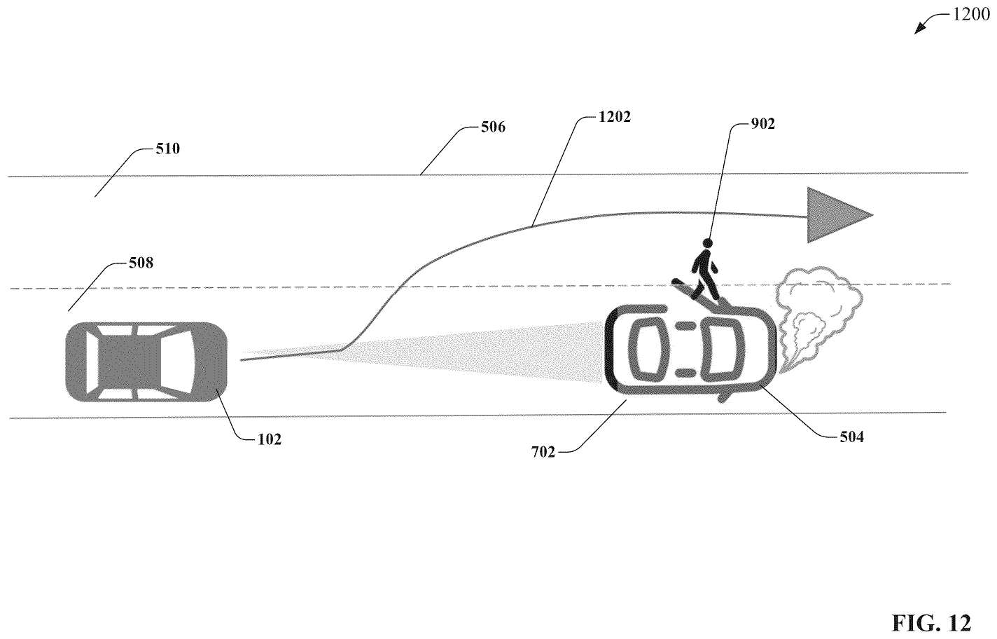

According to an embodiment, the vehicular behavior component 202 can, based upon a condition applicable to a second vehicle (e.g., vehicle 504), other than a first vehicle (e.g., vehicle 102, such as an autonomous vehicle), determine a predicted movement of the second vehicle (e.g., vehicle 504). Such a condition can comprise one or more of a variety of conditions, as later discussed in greater detail, such as a traffic condition, type of the second vehicle, capability of the first vehicle (e.g., acceleration or speed capability), a road condition, a position of a pedestrian or user of a second vehicle, an amount of time (e.g., that the second vehicle remains stopped or stationary), a current time, or another suitable condition. The vehicular behavior component 202 can utilize a defined vehicle behavior condition algorithm in order to generate a prediction of vehicle 504 behavior, compare one or more aspects of the condition to a lookup table or defined set of vehicle behaviors, and/or utilize machine learning (e.g., via the machine learning component 218) in order to generate such as prediction based on past vehicle encounters between other vehicles (e.g., and corresponding conditions), other than the second vehicle. In various embodiments, the overtake determination component 204 can then, based on the predicted movement being determined (e.g., via the overtake determination component 204) to satisfy a defined overtake condition, initiate an overtake action, applicable to the first vehicle (e.g., vehicle 102), to overtake the second vehicle (e.g., vehicle 504). In various embodiments, the overtake action can comprise the vehicle 102 initiating (e.g., via the overtake determination component 204) a lane change in order to overtake the vehicle 504. Such a lane change can be temporary (e.g., only long enough to pass the vehicle 504 before changing back to the lane prior to the lane change) or the vehicle 102 can remain in the new lane (e.g., an adjacent lane) after executing the overtake action of the vehicle 504. An exemplary trajectory for an overtake action is depicted as overtake path 1202 in FIG. 12. In some implementations, the predicted movement of the second vehicle (e.g., vehicle 504) can be based on a type of road applicable to the second vehicle (e.g., vehicle 504) or the first vehicle (e.g., vehicle 102). For example, if the road (e.g., road 506 as later discussed) comprises a highway, and the vehicle 504 is stopped on the highway, the vehicular behavior component 202 can predict that the vehicle 504 is not going to move from a stopped position on the highway, because it can be atypical for a vehicle to be stopped on a highway, and thus the defined overtake condition applicable in this scenario can comprise the vehicle 504 being stopped on the highway. However, if the road comprises a rural road on which stopping is predicted to occur, and the vehicle 504 is stopped on the road, the vehicular behavior component 202 can predict that the vehicle 504 will move and thus wait for a defined period of time before the overtake determination component 204 initiates the overtake action to overtake the vehicle 504. It is noted that the predicted movement can be determined (e.g., by overtake determination component 204) using a defined lookup table based on a comparison of an instant condition to known conditions, or can be determined, for instance, using machine learning (e.g., via the machine learning component 218) applied to past overtake actions and/or conditions.

According to an embodiment, a condition herein can comprise a traffic condition applicable to the second vehicle (e.g., vehicle 504). In this regard, the traffic determination component 206 can determine the traffic condition applicable to the second vehicle. Such a traffic condition can comprise a degree of traffic (e.g., based on a defined traffic criterion) applicable to the second vehicle. Further, the predicted movement can be determined (e.g., by the vehicular behavior component 202) based on the traffic condition. In some embodiments, a degree of traffic can be determined (e.g., via the traffic determination component 206), for instance, as a percentage of an actual speed of the vehicle 504 compared to an expected speed of the vehicle 504 (e.g., determined based on road signs, speed limits, or historical speeds applicable to the road on which the vehicle 504 is utilizing). In some embodiments, the traffic determination component 206 can obtain the traffic conditions from a global positioning system (GPS) of the vehicle 102 and/or a suitable traffic information service or database (e.g., via the communication component 212).

According to another embodiment, a condition herein can comprise a type of the second vehicle (e.g., vehicle 504). In this regard, the vehicle determination component 208 can determine the type of the second vehicle. In an implementation, the vehicle determination component 208 can determine the type of the second vehicle using a defined computer vision algorithm that compares images of the vehicle 504, captured via one or more sensors or cameras of the vehicle 102, in order to determine the type of the second vehicle and/or the model of the second vehicle. In other embodiments, the vehicle determination component 208 can determine a license plate or other identifier applicable to the vehicle 504, and compare that identifier to a database of vehicle information (e.g., accessed via the communication component 212), which can be utilized (e.g., via the vehicle determination component 208) to retrieve and/or determine corresponding vehicle type information applicable to the second vehicle (e.g., vehicle 504). In this regard, the database of vehicle information can comprise information regarding vehicle attributes comprising license plate information, vehicle type, vehicle make, vehicle model, vehicle model year, performance information, vehicle length, vehicle width, or other suitable information. Additionally, or alternatively, the vehicle determination component 208 can determine a length of the vehicle 504 based on a model or type of the vehicle 504, for instance, using the database of vehicle information. It is noted that the type of the vehicle 504 can be utilized (e.g., via the vehicular behavior component 202) to determine an expected stopping frequency or expected stopping location applicable to the vehicle 504. Further in this regard, the predicted movement can be determined (e.g., via the vehicular behavior component 202) based on the type of the second vehicle. According to an example, the type of the second vehicle can be a bus. In this regard, the overtake action (e.g., determined and/or initiated by the overtake determination component 204) can be based on a navigational rule applicable to the bus. For example, if a local rule or law prohibits passing a school bus, then the overtake determination component 204 can be configured not to initiate the overtake action of the second vehicle. In this regard, the navigational rule component 210 can, based on the type of the second vehicle, determine a navigational rule applicable to the second vehicle. In various embodiments, the navigational rule component 210 can compare the type of second vehicle (e.g., determined by the vehicle determination component 208) to defined rules or laws appliable to that type of vehicle. Such defined rules or laws can be stored in a database (e.g., in a memory 118 of the vehicle 102) and/or accessible via the communication component 212. In this regard, the overtake action can be determined (e.g., via the overtake determination component 204) based on the navigational rule(s). In another example, if a local rule or law prohibits passing in a construction zone, school zone, or another suitable type of zone, area, road, etc., then the overtake determination component 204 can be configured not to initiate the overtake action of the second vehicle while the vehicle 102 is in that locality. In some embodiments, the vehicle determination component 208 can determine a color of the second vehicle. In this regard, predicted movement can be determined (e.g., by the vehicular behavior component 202) based on the color of the second vehicle. In an embodiment, if the vehicle determination component 208 determines that the second vehicle comprises a yellow bus, rather than a green bus, then the vehicle determination component 208 can determine that the second vehicle comprises a school bus, rather than a city bus. The foregoing can be utilized by the vehicular behavior component 202 to determine predicted movement of the second vehicle and/or by the overtake determination component 204 to determine whether to initiate an overtake action (e.g., based in part on the color of the second vehicle).

According to another embodiment, a condition herein can comprise a road condition applicable to the first vehicle and/or the second vehicle. In this regard, the vehicle determination component 208 can determine the road condition using one or more sensors of the vehicle 102, retrieved from a road condition database communicatively coupled to the vehicle 102 via the communication component 212, and/or via vehicle to vehicle (V2V) communication between the vehicle 102 and other vehicles, other than the vehicle 102. Such a road condition can comprise one or more of dry pavement, wet pavement, snow-covered pavement, icy road, gravel road, uneven road surfaces, a construction zone, school zone, bus stop, a low-visibility zone, or other suitable road condition(s). For example, if the road on which the first vehicle and the second vehicle are operating is determined (e.g., via the vehicle determination component 208) to be snow covered, wet, or icy, the overtake determination component 204 can require additional defined space and/or time to complete the overtake action (e.g., since a slippery road can cause the vehicle 102 to execute the overtake action more slowly).

According to another embodiment, the vehicle determination component 208 can determine a logo (e.g., image(s), text, number(s), etc.) applicable to the second vehicle (e.g., printed on the second vehicle or affixed to the second vehicle, such as on a sign or a decal). For example, such a logo can comprise an identifier that the second vehicle (e.g., vehicle 504) comprises a taxi. In this regard, the predicted movement can be determined based on the logo (e.g., the vehicular behavior component 202 can predict movement of the second vehicle appliable to a taxi). According to another implementation, the vehicle determination component 208 can determine a light applicable to the second vehicle. For example, the vehicle determination component 208 can monitor and/or determine illumination of brake lights of the second vehicle. For instance, if the vehicle 504 is momentarily stopping, the brake lights of the vehicle 504 may remain illuminated, but if the vehicle 504 is stopping for an extended period of time, the brake lights of the vehicle 504 may dim or turn off (e.g., if the vehicle 504 is in a parking gear or a parked state). Similarly, if the vehicle determination component 208 determines that reverse lights of the second vehicle are illuminated, then the second vehicle may be predicted (e.g., by the vehicular behavior component 202) to be attempting to move. In this regard, the predicted movement (e.g., predicted by the vehicular behavior component 202) can be determined based on the light applicable to the second vehicle.

According to another implementation, the vehicle determination component 208 can determine a distance (e.g., distance 502) between the first vehicle (e.g., vehicle 102) and the second vehicle (e.g., vehicle 504) using distance sensor(s) 302. In this regard, the defined overtake condition herein can be based on the distance (e.g., distance 502) between the first vehicle and the second vehicle. For example, such a defined overtake condition can comprise the first vehicle being determined (e.g., via the vehicle determination component 208) to be within a defined threshold distance of the second vehicle before initiating the overtake action. In various embodiments, in order to determine the distance between the first vehicle and the second vehicle, the vehicle determination component 208 can determine a location of a first vehicle (e.g., vehicle 102) using a GPS sensor (e.g., of the vehicle electronic systems/devices 108) or another suitable sensor, device, or component of the vehicle 102. Further, the vehicle determination component 208 can determine a location (e.g., a second location) of the second vehicle using one or more distance sensors 302. A plurality of readings of the distance sensors 302 over time compared (e.g., via the vehicle determination component 208) to a speed of the first vehicle (e.g., vehicle 102), can be utilized in order to determine a speed differential between the first vehicle and the second vehicle, which can be utilized by the vehicle determination component 208 to predict future changes in the distance 502 between the first vehicle and the second vehicle.

In another embodiment, the vehicle determination component 208 can determine whether the second vehicle is stopped next to a defined object, such as a parking meter (not depicted). In this regard, an overtake action herein can be based on whether the vehicle determination component 208 determines that the second vehicle has parked within a defined distance of the parking meter. For example, if the second vehicle stops within the defined distance of the parking meter, the vehicular behavior component 202 can be configured to predict that the second vehicle will remain at the parking meter for an extended period time (e.g., a period of time longer than a threshold amount of time for which the overtake determination component 204 is configured to wait before initiating an overtake action). In this regard, the overtake determination component 204 can initiate the overtake action in response to a determination (e.g., via the vehicle determination component 208) that the second vehicle has stopped within the defined distance of the parking meter (or another suitable defined object).

In various embodiments, the vehicle determination component 208 can utilize one or more distance sensors 302 in order to determine three-dimensional positions of vehicles (e.g., vehicles other than the vehicle 102), pedestrians, or other objects relative to the vehicle 102 herein. In this regard, the vehicle determination component 208 and/or onboard vehicle system 104 can utilize and/or integrate data from the distance sensors 302 to generate a three-dimensional digital representation surrounding the vehicle 102. In various implementations, the distance sensors 302 can comprise one or more of a light detection and ranging (lidar) sensor, a radar sensor, an ultrasonic sensor, an infrared sensor, a laser sensor, a light emitting diode (LED) sensor, a capacitive sensor, a time of flight sensor, a hall effect sensor, or an optical sensor. In some embodiments a plurality of optical sensors or other suitable sensors can be utilized to determine or triangulate positions of vehicles, pedestrians, or other objects relative to the vehicle 102 herein. Further, plurality of optical sensors or other suitable sensors can be utilized to determine shapes (e.g., shapes of other vehicles), which can be utilized (e.g., by vehicle determination component 208) to determine a type, make, or model, or other suitable features or aspects of vehicles other than the vehicle 102.

According to an embodiment, the user determination component 214 can determine a position of a user associated with the second vehicle. It is noted that such as user can comprise a pedestrian, a driver, a passenger, or another suitable user. In this regard, the defined overtake condition herein can be based on the position of the user. For example, a user determined (e.g., via the user determination component 214) to be within a defined distance of a second vehicle herein can be determined to be associated with the second vehicle, or at least potentially associated with the second vehicle. Thus, a predicted amount of time that the second vehicle remains stopped can be based on actions of the user with respect to the second vehicle (e.g., ingress, egress, etc.) In this regard, the user determination component 214 can determine entry (e.g., ingress) or exit (e.g., egress) of the user from the second vehicle, and the defined overtake condition can be further based on the entry or the exit of the user from the second vehicle. Additionally, or alternatively, the user determination component 214 can determine a direction of navigation of the user. In this regard, the defined overtake condition can be further based on the direction of navigation of the user. For example, a user determined (e.g., via the user determination component 214) to be approaching the second vehicle can be determined to be entering the second vehicle. In this regard, the vehicular behavior component 202 can predict that the second vehicle will remain stationary for a defined amount of time (e.g., for the user to become secure inside the second vehicle). Thus, the overtake determination component 204 can determine to overtake the second vehicle or to wait, depending on whether the condition (e.g., a user entering the second vehicle) is configured to satisfy a defined overtake condition.

According to an embodiment, the timer component 216 can determine an amount of time that the second vehicle (e.g., vehicle 504) remains stationary. In this regard, the defined overtake condition can be based on the amount of time that the second vehicle remains stationary. For example, the overtake determination component 204 can determine whether the amount of time that the second vehicle remains stationary exceeds a defined allotted amount of time for the first vehicle not to overtake the second vehicle. It is noted the amount of time can vary depending on the type of vehicle detected (e.g., by the vehicle determination component 208). In one or more nonlimiting examples, a timer can be set (e.g., by the timer component 216) to approximately thirty seconds for a school bus, fifteen seconds for a taxi, one minute for a delivery truck, and/or thirty seconds for a passenger car. If such a time threshold corresponding to the type of second vehicle is determined (e.g., by the overtake determination component 204) to be exceeded by the amount of time that the first vehicle has waited, the overtake determination component 204 can be configured to initiate an overtake action. In various embodiments, if the first vehicle stops in a low traffic area, but no pedestrians are detected within a defined threshold distance of the second vehicle (e.g., area 702), the timer component 216 can set the timer and initiate the overtake action if a defined amount of time elapses. It is noted that the threshold for the timer can vary depending on one or more of a variety of factors, such as type of vehicle, quantity of associated pedestrians or users, time of day, day of week, week of month, month of year, weather conditions, road conditions, or other suitable factors.

According to an embodiment, the communication component 212 can receive, from the second vehicle, navigation information representative of a future navigational operation applicable to the second vehicle. It is noted that the navigation information can comprise current and/or future actions to be performed by the second vehicle. In this regard, such navigation information can comprise an amount of time that the second vehicle is to be stopped at a location and/or when the second vehicle is scheduled to move again. Further in this regard, a defined overtake condition herein can be based on the future navigational operation. For example, the overtake determination component 204 can determine whether to initiate an overtake action based on an amount of time that the second vehicle is scheduled to remain at a location and/or when the second vehicle is scheduled to move from a location. In various embodiments, such navigation information can be communicated to the first vehicle (e.g., via the communication component 212) from a network 114 (e.g., a cloud-based network) and/or directly from the second vehicle. Such communication can comprise vehicle to vehicle (V2V) communication between vehicle 102 and vehicle 504 (e.g., via Bluetooth, 5G, 6G, cloud-based, or other suitable V2V or vehicle to everything (V2E) communication).

According to an embodiment, the machine learning component 218 can, using machine learning applied to past overtake actions other than the overtake action and other vehicles other than the second vehicle, generate an overtake model (e.g., of the models 220). In this regard. the overtake determination component 204 can initiate the overtake action using the overtake model. For example, the machine learning component 218 can learn to predict movements of vehicles herein and/or overtake conditions. In this regard, the machine learning component 218 can determine normal or expected vehicle behaviors according to type of vehicle, road conditions, traffic conditions, time conditions, seasonal conditions, model of vehicle, user or pedestrian conditions, or other suitable factors, and determine suitable corresponding overtake conditions that can be utilized by one or more other components of the vehicle 102.

Various embodiments herein can employ artificial-intelligence or machine learning systems and techniques to facilitate learning user behavior, context-based scenarios, preferences, etc. in order to facilitate taking automated action with high degrees of confidence. Utility-based analysis can be utilized to factor benefit of taking an action against cost of taking an incorrect action. Probabilistic or statistical-based analyses can be employed in connection with the foregoing and/or the following.

It is noted that systems and/or associated controllers, servers, or machine learning components herein can comprise artificial intelligence component(s) which can employ an artificial intelligence (A.I.) model and/or machine learning (M.L.) or an M.L. model that can learn to perform the above or below described functions (e.g., via training using historical training data and/or feedback data).

In some embodiments, machine learning component 218 can comprise an A.I. and/or M.L. model that can be trained (e.g., via supervised and/or unsupervised techniques) to perform the above or below-described functions using historical training data comprising various context conditions that correspond to various augmented network optimization operations. In this example, such an A.I. and/or M.L. model can further learn (e.g., via supervised and/or unsupervised techniques) to perform the above or below-described functions using training data comprising feedback data, where such feedback data can be collected and/or stored (e.g., in memory) by the machine learning component 218. In this example, such feedback data can comprise the various instructions described above/below that can be input, for instance, to a system herein, over time in response to observed/stored context-based information.

A.I./M.L. components herein can initiate an operation(s) associated with a based on a defined level of confidence determined using information (e.g., feedback data). For example, based on learning to perform such functions described above using feedback data, performance information, and/or past performance information herein, a machine learning component 218 herein can initiate an operation associated with determining various thresholds herein (e.g., a motion pattern thresholds, input pattern thresholds, similarity thresholds, authentication signal thresholds, audio frequency thresholds, or other suitable thresholds).

In an embodiment, the machine learning component 218 can perform a utility-based analysis that factors cost of initiating the above-described operations versus benefit. In this embodiment, the machine learning component 218 can use one or more additional context conditions to determine various thresholds herein.

To facilitate the above-described functions, a machine learning component 218 herein can perform classifications, correlations, inferences, and/or expressions associated with principles of artificial intelligence. For instance, the machine learning component 218 can employ an automatic classification system and/or an automatic classification. In one example, the machine learning component 218 can employ a probabilistic and/or statistical-based analysis (e.g., factoring into the analysis utilities and costs) to learn and/or generate inferences. The machine learning component 218 can employ any suitable machine-learning based techniques, statistical-based techniques and/or probabilistic-based techniques. For example, the machine learning component 218 can employ expert systems, fuzzy logic, support vector machines (SVMs), Hidden Markov Models (HMMs), greedy search algorithms, rule-based systems, Bayesian models (e.g., Bayesian networks), neural networks, other non-linear training techniques, data fusion, utility-based analytical systems, systems employing Bayesian models, and/or the like. In another example, the machine learning component 218 can perform a set of machine-learning computations. For instance, the machine learning component 218 can perform a set of clustering machine learning computations, a set of logistic regression machine learning computations, a set of decision tree machine learning computations, a set of random forest machine learning computations, a set of regression tree machine learning computations, a set of least square machine learning computations, a set of instance-based machine learning computations, a set of regression machine learning computations, a set of support vector regression machine learning computations, a set of k-means machine learning computations, a set of spectral clustering machine learning computations, a set of rule learning machine learning computations, a set of Bayesian machine learning computations, a set of deep Boltzmann machine computations, a set of deep belief network computations, and/or a set of different machine learning computations.

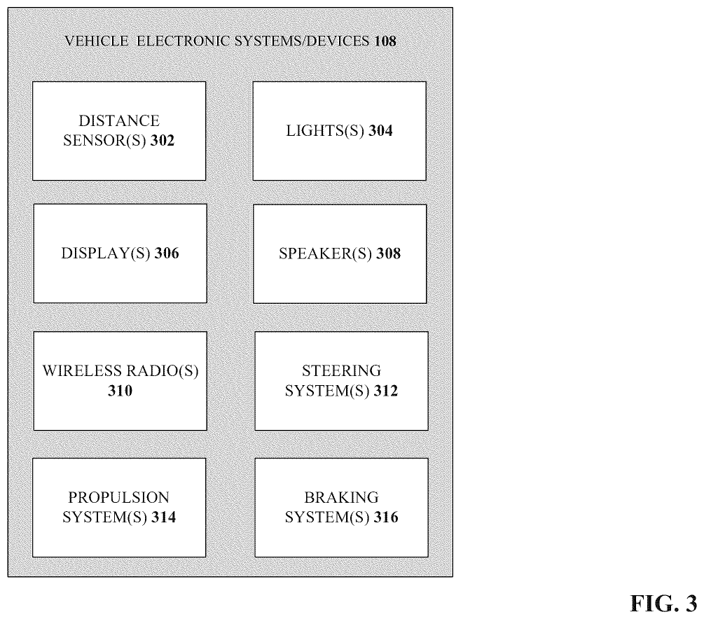

FIG. 3 illustrates a block diagram of example, non-limiting vehicle electronic systems/devices 108 in accordance with one or more embodiments described herein. Repetitive description of like elements employed in other embodiments described herein is omitted for sake of brevity. In various embodiments, the vehicle electronic systems/devices 108 can comprise one or more of distance sensors 302 (e.g., sensors external or internal to the vehicle 102 that are arranged to detect distance between the vehicle 102 and other objects (e.g., other vehicles, pedestrians, etc.) and/or to determine potential collisions, such as one or more of a light detection and ranging (lidar) sensor, a radar sensor, an ultrasonic sensor, an infrared sensor, a laser sensor, a light emitting diode (LED) sensor, a capacitive sensor, a time of flight sensor, a hall effect sensor, or an optical sensor, or another suitable sensors), light(s) 304, display(s) 306 (e.g., infotainment devices, touchscreen displays, etc.), speaker(s) 308, and/or wireless radio(s) 310. In various embodiments, the vehicle electronic systems/devices 108 can additionally, or alternatively comprise one or more of steering system(s) 312, propulsion system(s) 314, and/or braking system(s) 316. The steering system(s) 312 can comprise one or more of a steering wheel, steering column, steering gearbox, steering rack and pinion, pitman arm, idler arm, tie rod(s), steering knuckles, power steering pump or electric steering motor, vehicle wheels and tires, or other suitable steering system components. The propulsion system(s) 314 can comprise one or more of an engine, transmission, driveshaft, differential, axle(s), wheels/tires, traction inverter, electric motor, or other suitable propulsion system components. The braking system(s) 316 can comprise one or more of a brake pedal, brake booster, master cylinder, brake lines, brake calipers/pads, wheel cylinders and brake shoes, brake rotors or drums, brake fluid, electric vehicle propulsion components (e.g., for regenerative braking), or other suitable braking system components.

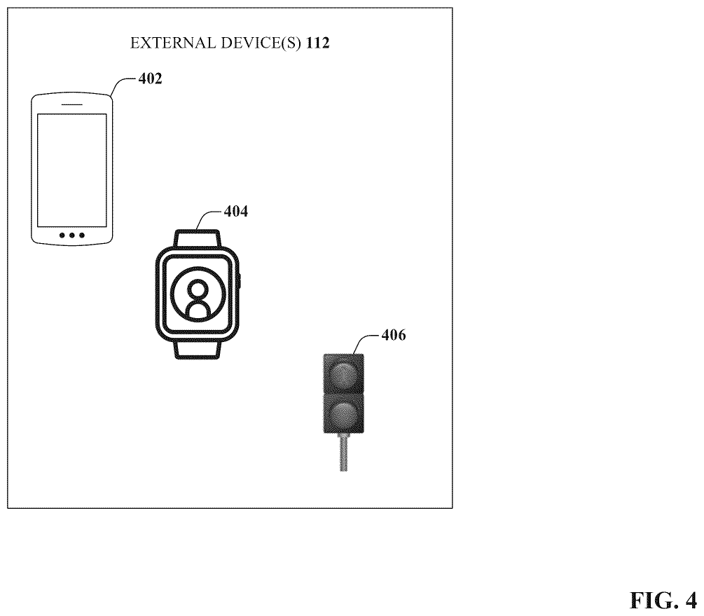

FIG. 4 illustrates a block diagram of example, non-limiting external devices 112 in accordance with one or more embodiments described herein. In this regard, the external devices 112 can comprise mobile device 402 (e.g., a smartphone), wearable device 404 (e.g., a smartwatch, headphones, augmented reality headset or glasses, virtual reality headset or glasses, mixed reality headset or glasses, smart ring, smart glasses, smart jewelry, smart clothing, fitness tracking device, or another suitable wearable device), a traffic signal 406 (e.g., a traffic light, cross walk signal, or another suitable traffic signal), or other suitable external devices. It is noted that the traffic signal 406 can be configured to display a corresponding signal, such as a do-not-cross signal, danger signal, visual signal, color-coded signal, or another suitable signal traffic signal.

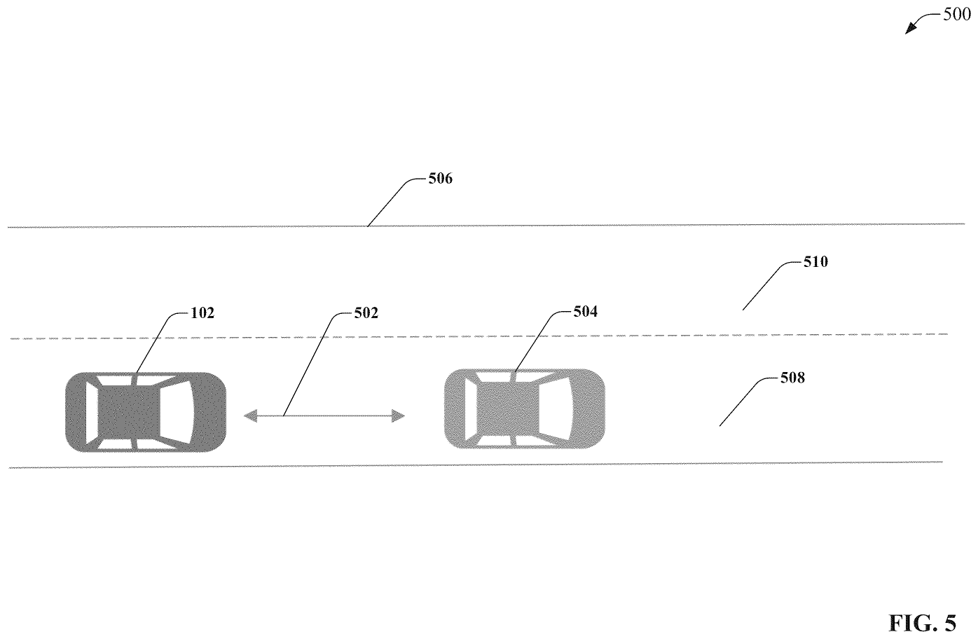

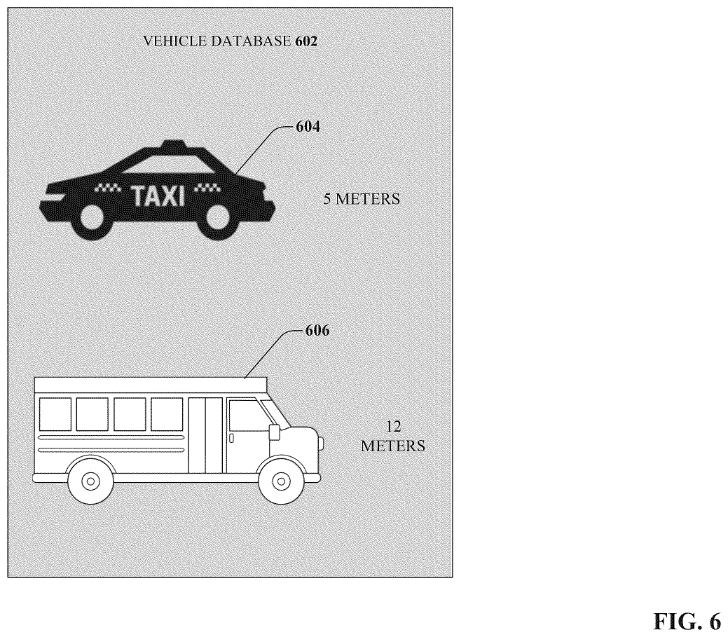

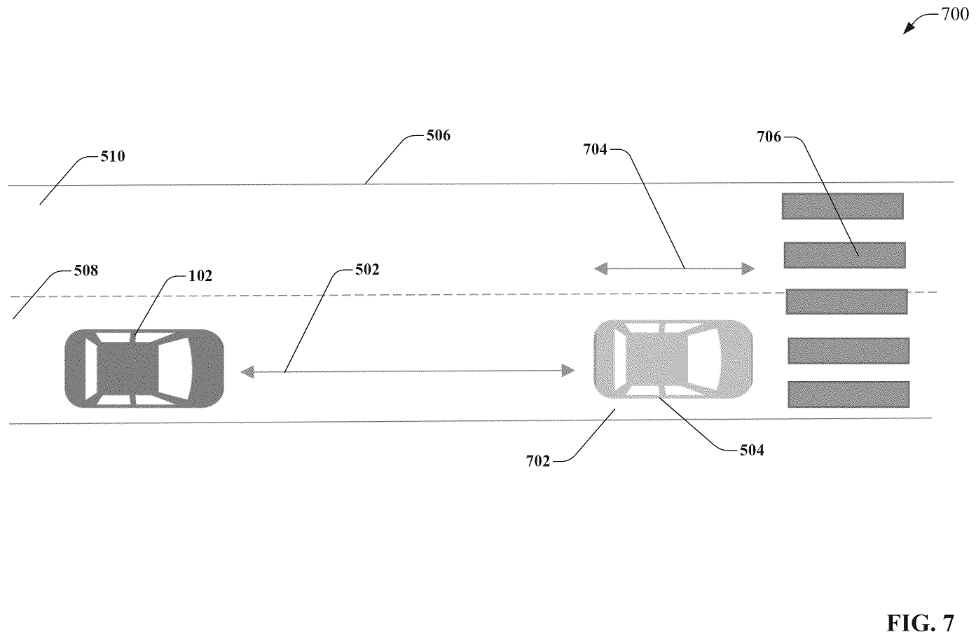

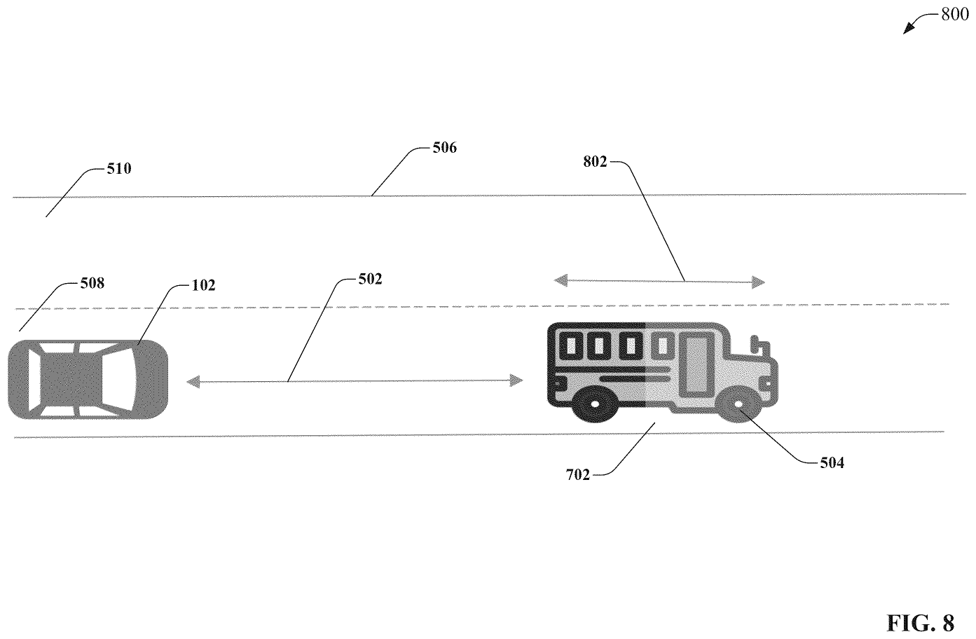

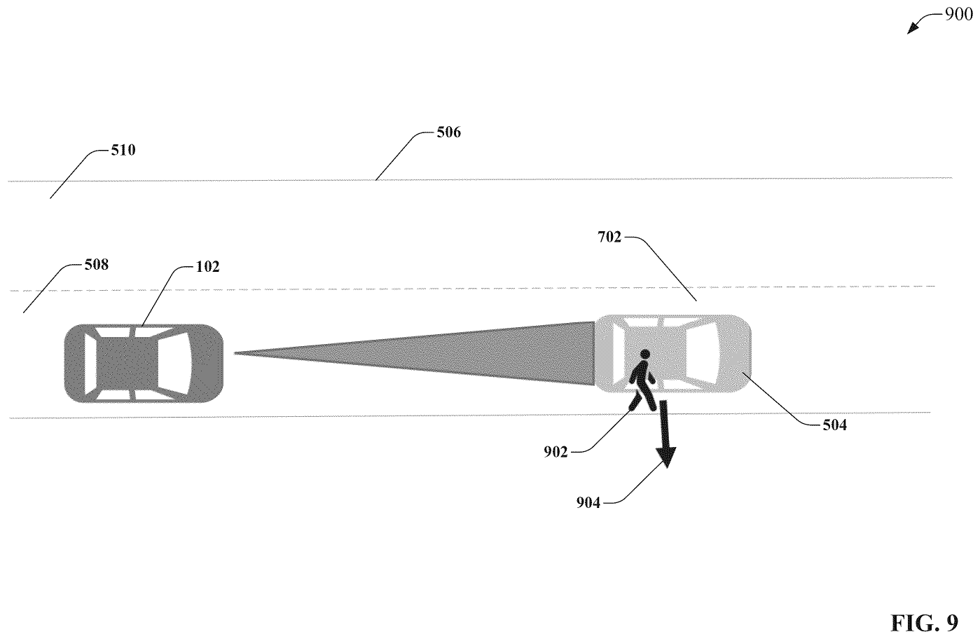

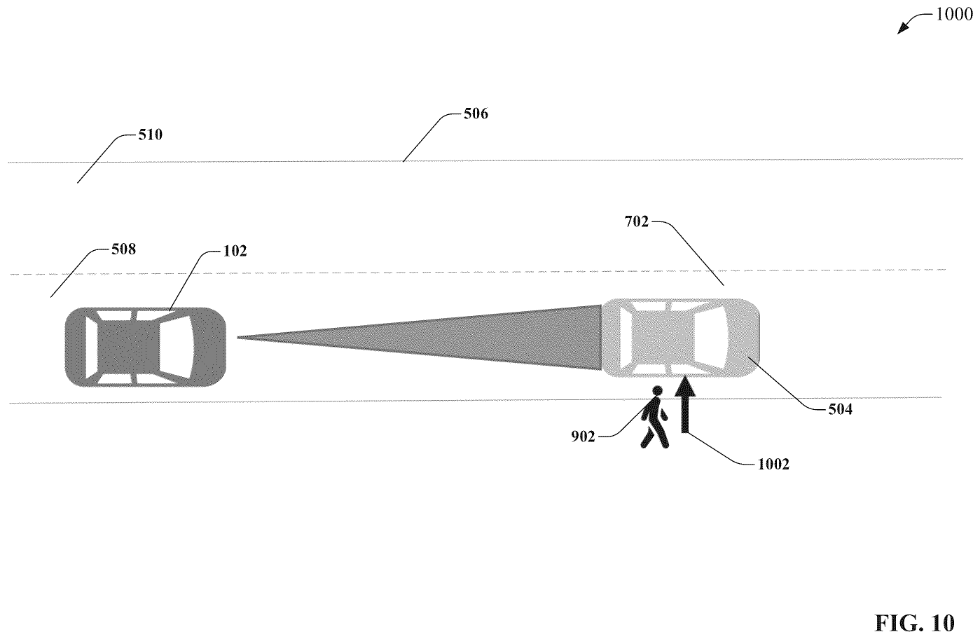

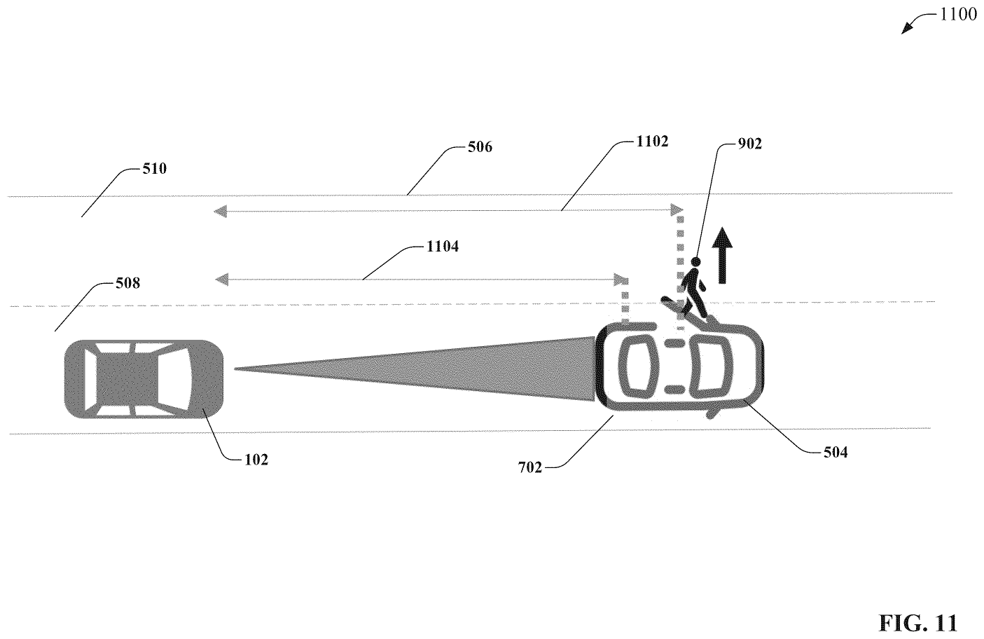

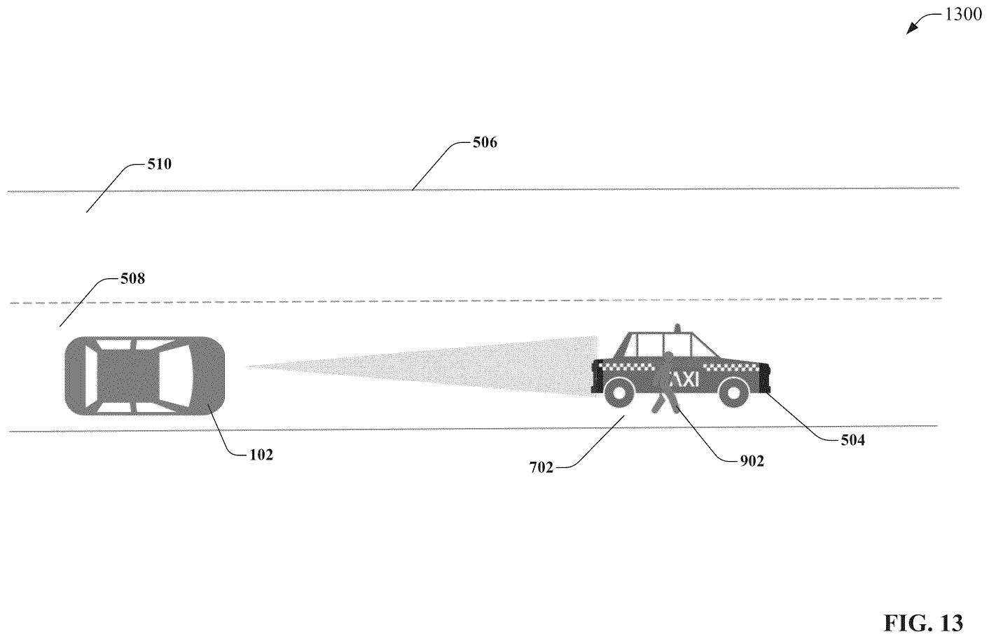

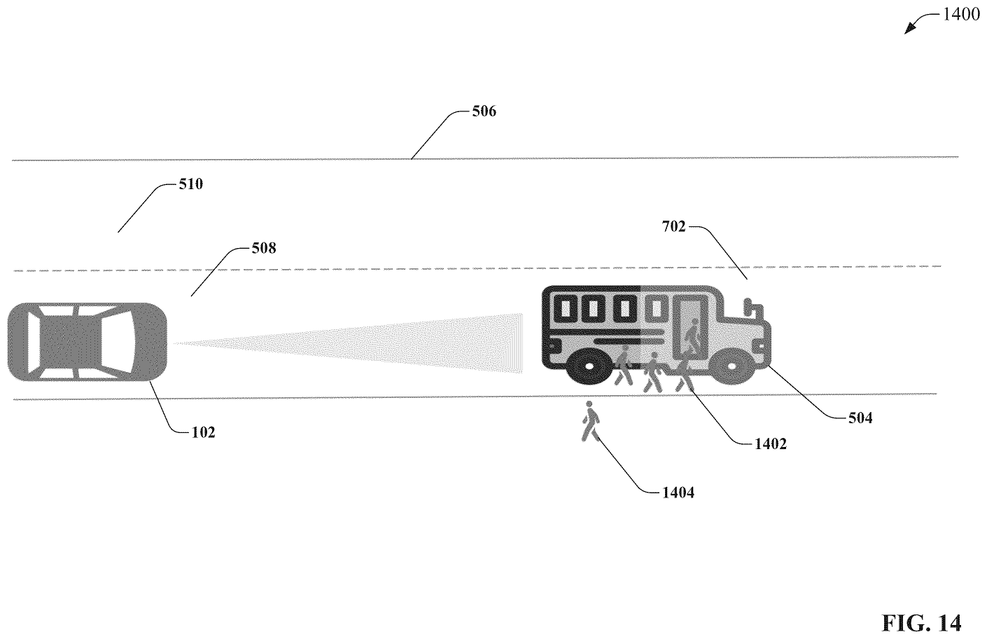

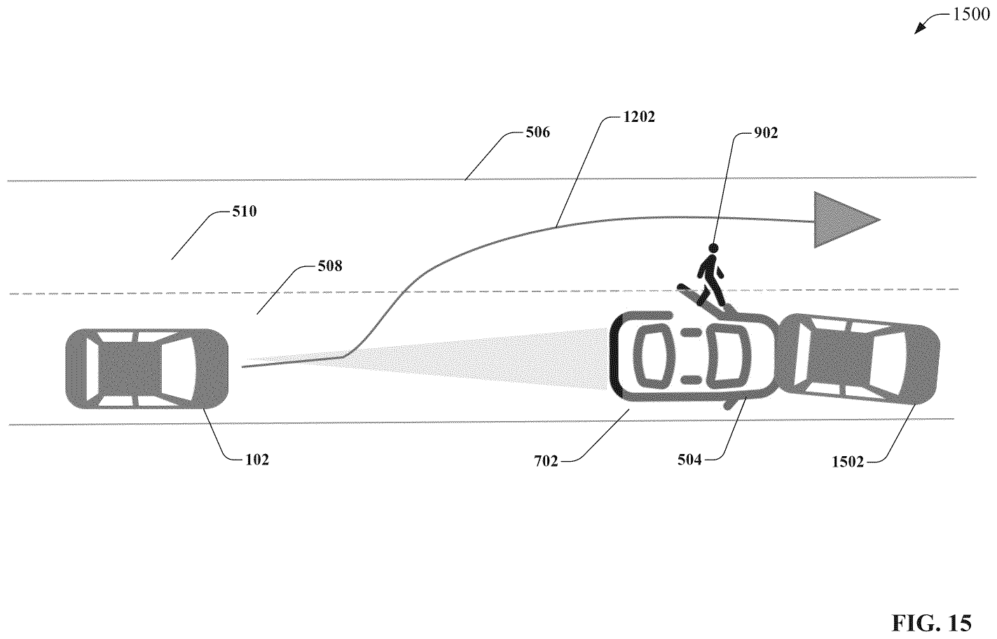

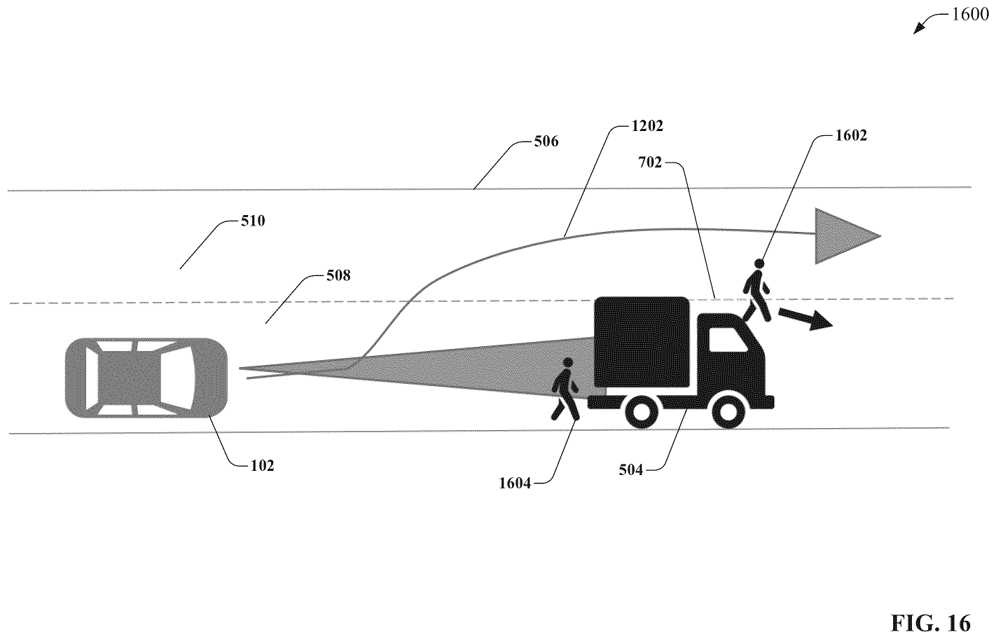

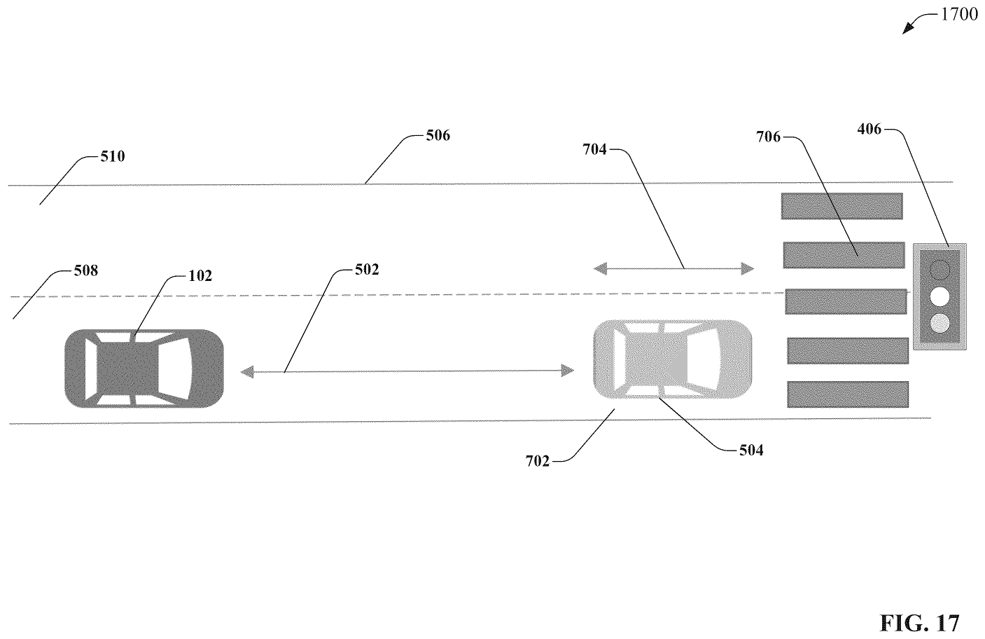

FIGS. 5-17 illustrate example, non-limiting scenarios and/or examples or embodiments in accordance with various embodiments described herein. In some embodiments, such scenarios can comprise a series of events or steps, however, the scenarios are presented in a non-limiting sequence and/or one or more steps or scenarios can be added, duplicated, omitted, etc.

Scenario 500 can comprise vehicle 102, vehicle 504, road 506, lane 508, lane 510. In scenario 500, the vehicle 102 is driving to its destination in autonomous mode (e.g., using a GPS of the vehicle 102). The traffic determination component 206 can determine the traffic conditions from a GPS of the vehicle 102 and/or a suitable traffic information service (e.g., via the communication component 212). If the vehicle determination component 208 and/or vehicular behavior component 202 determines that vehicle 504 has stopped, the traffic determination component 206 can determine corresponding traffic conditions applicable to the road 506 (e.g., whether low, medium, or high traffic according to a defined traffic criterion). If the traffic conditions are determined (e.g., by the traffic determination component 206) to comprise low traffic, then the vehicle 102 can be determined not to be stopping at a current position (e.g., under such low traffic conditions) and thus neither should the vehicle 504. However, if traffic conditions are determined (e.g., by the traffic determination component 206) to be high, the vehicle 504 can be expected to periodically stop (e.g., due to a traffic jam). Once the vehicle 102 has stopped in a low traffic area, the vehicle determination component 208 can determine the distance 502 between the vehicle 102 and the vehicle 504. It is noted that the vehicle determination component 208 can detect oncoming traffic (e.g., in lane 510 if lane 510 is configured for traffic in a direction opposite to the lane 508) or whether lane 510 is configured for traveling in the same direction as the lane 508.

Using a defined car model recognition algorithm, the vehicle determination component 208 can determine a type or model of the vehicle 504, for instance, using a defined computer vision algorithm and/or one or more cameras or other sensors of the vehicle 102. The foregoing can be beneficial for determining an overtake action herein, for instance, because some models or types of vehicle can be more likely to stop and pick up or drop off people, such a taxi 604 or bus 606. Once the vehicle determination component 208 has determined the type or model of the vehicle 504, the vehicle determination component 208 can determine a length of the vehicle 504, for instance, from a vehicle database 602. Such a vehicle database 602 can be accessible by the vehicle 102 (e.g., via the communication component 212) from a network 114 (e.g., a cloud-based network) and/or stored locally on the vehicle 102 itself (e.g., in memory 118). Based on the type or model of the vehicle 504, the onboard vehicle system 104 can gain can insight into whether the vehicle 504 is likely to stop, even in low traffic. For example, a taxi or a school bus can be likely to frequently stop, but a private passenger car is less likely to frequently stop.

In scenario 700, the user determination component 214 can detect users or pedestrians at a defined distance (e.g., depending on the type of vehicle 504) from the vehicle 102, a defined distance from the vehicle 504, and/or within a defined area 702 of the vehicle 504 (e.g., users or pedestrians close to door(s) of the vehicle 504). As an example, for a sedan, the area 702 can be from distance 502 to length 704 of the vehicle 504. Thus, in scenario 700, the pedestrian crossing 706 can be ignored by the vehicle 102 for the purposes of overtake determination of the vehicle 504, however, it is noted that the vehicle 102 can be configured to avoid a collision with any vehicle and/or pedestrian/user, for instance, using one or more sensors of the vehicle 102 and/or automated braking, etc. In scenario 800 (e.g., when the vehicle 504 is determined by the vehicle determination component 208 to comprise a school bus), the area 702 can be determined by the vehicle determination component 208 to comprise a defined portion of the vehicle 504 (e.g., just the front right-side area of the bus). In an example, the defined portion of the vehicle 504 can comprise half of the length 802 of the vehicle 504. In this nonlimiting scenario, the user determination component 214 can be configured to ignore pedestrians on the left side of the bus, since the bus has only one door (e.g., on the right side of the bus). It is noted that, in various embodiments, the area 702 can be determined (e.g., via the vehicle determination component 208) based on a length of the vehicle 504 and/or based on a model or type of the vehicle 504, as determined by the vehicle determination component 208.

In scenarios 900 and 1000, the user determination component 214 can determine whether a pedestrian or user is exiting the vehicle 504 (e.g., in direction 904) or is entering the vehicle 504 (e.g., in direction 1002). In the nonlimiting scenario 900, the vehicle 504 can comprise a taxi, and no pedestrian is detected by the user determination component 214 external to the vehicle 504 until the vehicle 504 is determined to stop. The vehicular behavior component 202 can thus determine that the vehicle 504 is conducting a pedestrian drop-off. In nonlimiting scenario 1000, the vehicle 504 can comprise a taxi, a pedestrian or user is detected by the user determination component 214 external to the vehicle 504 (e.g., in direction 1002) before the vehicle 504 is determined to stop (e.g., by the vehicle determination component 208), and after the vehicle 504 stops, the pedestrian or user is no longer detected by the user determination component 214 (e.g., using one or more sensors of the vehicle 102). The vehicular behavior component 202 can thus determine that the vehicle 504 is conducting a pedestrian pick-up. The vehicle determination component 208 can determine which door of the vehicle 504 is opened using, for instance, a defined car part recognition algorithm (e.g., a computer vision algorithm) and/or distance measurements relative to the vehicle 504 and/or vehicle 102. In scenario 1100, distance 1102 can represent a determined distance between the vehicle 102 and a front door of the vehicle 504, and the distance 1104 can represent a determined distance between the vehicle 102 and a rear door of the vehicle 504.

Based on the predicted behavior of the vehicle 504 (e.g., predicted by the vehicular behavior component 202), the overtake determination component 204 can determine whether or not to modify autonomous driving behavior applicable to the vehicle 102. For instance, in scenario 1200, the vehicle determination component 208 can determine that the vehicle 504 comprises a passenger car stopped in a low traffic area, which is thus unexpected to stop (e.g., due to a mechanical breakdown). The vehicle determination component 208 can determine that a driver-side door of the vehicle 504 is opened, and the user determination component 214 can determine that a user 902 has exited the vehicle 504. The overtake determination component 204 can then determine to overtake the vehicle 504 (e.g., along overtake path 1202). However, the overtake determination component 204 can generate a prompt to be presented (e.g., via the one or more input devices 106) to a user of the vehicle 102, which can enable a user of the vehicle 102 to override the overtake action, for instance, if the user wishes to provide assistance to the vehicle 504. In some embodiments, the overtake determination component 204 can be configured to initiate an overtake action of the vehicle 504, for instance, if the user 902 is determined (e.g., via the user determination component 214) to have exited the vehicle 504. However, the overtake determination component 204 can instead cause the vehicle 102 to remain in place, for instance, if an emergency vehicle (e.g., a police car, ambulance, etc.) is detected by the vehicle determination component 208.

In an example, if the vehicle 504 is determined (e.g., by the vehicle determination component 208 based on one more defined identifiers applicable to the vehicle 504) to comprise a participant to a ride sharing service, the vehicle 504 can be predicted (e.g., via the vehicular behavior component 202) to have a user exit the vehicle 504, followed by another user entering the vehicle 504. In this regard, the vehicle determination component 208 can continue monitoring the doors of the vehicle 504 once a user has exited the vehicle 504, and the vehicle determination component 208 can determine if the door is left open (e.g., for a new occupant) or closed (e.g., for a future occupant).

In scenario 1300, the vehicle determination component 208 can determine that the vehicle 504 comprises a taxi stopped in a low traffic area (e.g., normal and/or expected to stop). The user determination component 214 can determine that a user 902 is in the area 702, and the vehicle determination component 208 can determine that a door of the vehicle 504 is opened. The overtake determination component 204 can determine to wait, rather than overtake the vehicle 504. In some embodiments, if the vehicle determination component 208 detects that there is another vehicle approaching from the rear of the vehicle 102, the onboard vehicle system 104 can enable hazard lights of the vehicle 102. In further embodiments, the vehicle determination component 208 can determine whether hazard lights of the vehicle 504 are enabled. In this regard, the overtake determination component 204 can determine whether to overtake the vehicle 504 based on whether hazard lights of the vehicle 504 are enabled. For instance, the overtake determination component 204 can determine to overtake the vehicle 504 in response to a determination by the vehicle determination component 208 that the hazard lights of the vehicle 504 are enabled. Additionally, or alternatively, the vehicle determination component 208 can monitor brake lights of the vehicle 504. For instance, if the vehicle 504 is momentarily stopping, the brake lights of the vehicle 504 may persist as illuminated, however, if the vehicle 504 is stopping for an extended period of time, the brake lights of the vehicle 504 can dim or turn off (e.g., of the vehicle 504 is in a park gear or a parked state).

In scenario 1400, the vehicle determination component 208 can determine that the vehicle 504 comprises a school bus stopped in low traffic area (e.g., and thus expected to stop). The user determination component 214 can detect a plurality of pedestrians 1402 in the area 702. However, pedestrian 1404 can be ignored by the user determination component 214, for instance, because the pedestrian 1404 is moving away from the vehicle 504 and/or is outside the area 702. The overtake determination component 204 can then determine to overtake the vehicle 504 (e.g., if local rules permit). In this regard, an overtake action herein can be based on a navigational rule applicable to the bus. The vehicle determination component 208 can facilitate (e.g., via one or more sensors or cameras of the vehicle 102) sign recognition, lane recognition, and/or comparison of a location of the vehicle 102 or vehicle 504 to a rule database. This can enable the navigational rule component 210 to determine whether an overtake action is permitted at that location and/or whether an overtake action of the type of vehicle 504 is permitted. It is noted that an amount of time that the vehicle 102 can be configured (e.g., by the overtake determination component 204) to wait for the pedestrians 1402 to enter the vehicle 504 can be based on a quantity of the pedestrians 1402 determined by the user determination component 214. In this regard, the timer component 216 can set a timer during which the overtake determination component 204 can wait for the vehicle 504 to move before initiating an overtake action, and the timer can vary depending upon the quantity of pedestrians 1402 detected, by the user determination component 214, in the area 702. The wait time, according to the quantity of pedestrians, can be predefined (e.g., in a lookup table) according to type of vehicle and/or quantity of pedestrians and/or can be determined using machine learning (e.g., via the machine learning component 218) based on past overtake scenarios and/or conditions.

In scenario 1500, the vehicle 504 can be determined (e.g., via the vehicle determination component 208) to be involved in a collision with the vehicle 1502 (e.g., regardless of the traffic conditions). The vehicle determination component 208 can determine, for instance, that the vehicle 504 is involved in a collision due to a change in the shape of the body of the vehicle 504 (e.g., dents, cracks, protruding parts, etc.) using one or more cameras or sensors of the vehicle 102. In other embodiments, the vehicle determination component 208 can determine whether the vehicle 504 is involved in a collision to due to a determined abrupt change in speed of the vehicle 504. In this regard, the vehicle 504 can be determined (e.g., by vehicle determination component 208) to be stopped, and that a user 902 (e.g., a driver of the vehicle 504) has stepped out of the vehicle 504 (e.g., as determined by the user determination component 214). The overtake determination component 204 can then determine to overtake the vehicle 504 (e.g., unless an override request is received from a user of the vehicle 102). It is also noted that, if the vehicle 102 stops in a low traffic area, but no pedestrians are detected, the timer component 216 can set the timer and the overtake determination component 204 can initiate the overtake action, for instance, if a defined amount of time elapses.

In scenario 1600, the vehicle 504 can be determined (e.g., by the vehicle determination component 208) to comprise a delivery truck (e.g., and thus expected to make stops). The vehicle determination component 208 can determine that a driver door and/or a rear door of the vehicle 504 is opened. The user determination component 214 can further determine that a driver 1602 and/or driver 1604 is walking away from the vehicle 504. The overtake determination component 204 can thus determine to overtake the vehicle 504 (e.g., unless an override request is received from a user of the vehicle 102).

In scenario 1700, the vehicle 504 can be determined to be stopped at an intersection comprising traffic signal 406. If the traffic signal is determined (e.g., using the vehicle determination component 208) to be red, the overtake determination component 204 can determine not to overtake the vehicle 504 (e.g., unless an override request is received from a user of the vehicle 102), as the vehicle 102 could otherwise move into an intersection, potentially posing a risk to the vehicle 102 and/or other vehicles or objects. In some embodiments, the overtake determination component 204 can be configured not to initiate the overtake action if the traffic signal 406 is determined by the vehicle determination component 208 to be red. However, if the vehicle determination component 208 determines that the traffic light is green and that the vehicle 504 remains stopped for a defined amount of time, the overtake determination component 204 can be configured to initiate the overtake action if the vehicle determination component 208 also determines (e.g., using one or more sensors or cameras of the vehicle 102) that there exists room on the road 506 for the vehicle 102 to conduct the overtake action.

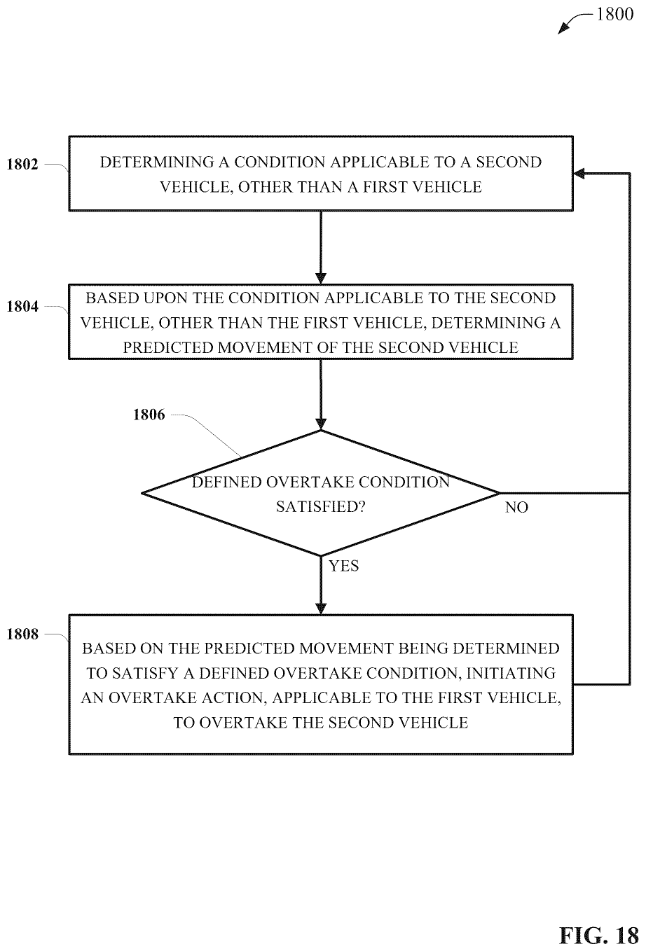

FIG. 18 illustrates a block flow diagram for a process 1800 associated with an overtake decision (e.g., for a vehicle) based on behavior of another vehicle in accordance with one or more embodiments described herein. At 1802, the process 1800 can comprise determining (e.g., via the traffic determination component 206, vehicle determination component 208, navigational rule component 210, user determination component 214, machine learning component 218, or another component of the vehicle 102) a condition applicable to a second vehicle (e.g., vehicle 504), other than a first vehicle (e.g., vehicle 102). At 1804, the process 1800 can comprise, based upon the condition applicable to the second vehicle, other than the first vehicle, determining (e.g., via the vehicular behavior component 202) a predicted movement of the second vehicle. At 1806, if a defined overtake condition satisfied is determined (e.g., via the overtake determination component 204) to be satisfied, the process can proceed to 1808. Otherwise, the process can return to 1802. At 1808, the process 1800 can comprise based on the predicted movement being determined (e.g., via the overtake determination component 204) to satisfy a defined overtake condition, initiating (e.g., via the overtake determination component 204) an overtake action, applicable to the first vehicle, to overtake the second vehicle.

Systems described herein can be coupled (e.g., communicatively, electrically, operatively, optically, inductively, acoustically, etc.) to one or more local or remote (e.g., external) systems, sources, and/or devices (e.g., electronic control systems (ECU), classical and/or quantum computing devices, communication devices, etc.). For example, system 100 (or other systems, controllers, processors, etc.) can be coupled (e.g., communicatively, electrically, operatively, optically, etc.) to one or more local or remote (e.g., external) systems, sources, and/or devices using a data cable (e.g., High-Definition Multimedia Interface (HDMI), recommended standard (RS), Ethernet cable, etc.) and/or one or more wired networks described below.

In some embodiments, systems herein can be coupled (e.g., communicatively, electrically, operatively, optically, inductively, acoustically, etc.) to one or more local or remote (e.g., external) systems, sources, and/or devices (e.g., electronic control units (ECU), classical and/or quantum computing devices, communication devices, etc.) via a network. In these embodiments, such a network can comprise one or more wired and/or wireless networks, including, but not limited to, a cellular network, a wide area network (WAN) (e.g., the Internet), and/or a local area network (LAN). For example, system 100 can communicate with one or more local or remote (e.g., external) systems, sources, and/or devices, for instance, computing devices using such a network, which can comprise virtually any desired wired or wireless technology, including but not limited to: powerline ethernet, VHF, UHF, AM, wireless fidelity (Wi-Fi), BLUETOOTH®, fiber optic communications, global system for mobile communications (GSM), universal mobile telecommunications system (UMTS), worldwide interoperability for microwave access (WiMAX), enhanced general packet radio service (enhanced GPRS), third generation partnership project (3GPP) long term evolution (LTE), third generation partnership project 2 (3GPP2) ultra-mobile broadband (UMB), high speed packet access (HSPA), Zigbee and other 802.XX wireless technologies and/or legacy telecommunication technologies, Session Initiation Protocol (SIP), ZIGBEE®, RF4CE protocol, WirelessHART protocol, L-band voice or data information, 6LoWPAN (IPv6 over Low power Wireless Area Networks), Z-Wave, an ANT, an ultra-wideband (UWB) standard protocol, and/or other proprietary and non-proprietary communication protocols. In this example, system 100 can thus include hardware (e.g., a central processing unit (CPU), a transceiver, a decoder, an antenna (e.g., a ultra-wideband (UWB) antenna, a BLUETOOTH® low energy (BLE) antenna, etc.), quantum hardware, a quantum processor, etc.), software (e.g., a set of threads, a set of processes, software in execution, quantum pulse schedule, quantum circuit, quantum gates, etc.), or a combination of hardware and software that facilitates communicating information between a system herein and remote (e.g., external) systems, sources, and/or devices (e.g., computing and/or communication devices such as, for instance, a smart phone, a smart watch, wireless earbuds, etc.).

Systems herein can comprise one or more computer and/or machine readable, writable, and/or executable components and/or instructions that, when executed by processor (e.g., a processing unit 116 which can comprise a classical processor, a quantum processor, etc.), can facilitate performance of operations defined by such component(s) and/or instruction(s). Further, in numerous embodiments, any component associated with a system herein, as described herein with or without reference to the various figures of the subject disclosure, can comprise one or more computer and/or machine readable, writable, and/or executable components and/or instructions that, when executed by a processor, can facilitate performance of operations defined by such component(s) and/or instruction(s). Consequently, according to numerous embodiments, system herein and/or any components associated therewith as disclosed herein, can employ a processor (e.g., processing unit 116) to execute such computer and/or machine readable, writable, and/or executable component(s) and/or instruction(s) to facilitate performance of one or more operations described herein with reference to system herein and/or any such components associated therewith.

Systems herein can comprise any type of system, device, machine, apparatus, component, and/or instrument that comprises a processor and/or that can communicate with one or more local or remote electronic systems and/or one or more local or remote devices via a wired and/or wireless network. All such embodiments are envisioned. For example, a system (e.g., a system 100 or any other system or device described herein) can comprise a computing device, a general-purpose computer, field-programmable gate array, AI accelerator application-specific integrated circuit, a special-purpose computer, an onboard computing device, a communication device, an onboard communication device, a server device, a quantum computing device (e.g., a quantum computer), a tablet computing device, a handheld device, a server class computing machine and/or database, a laptop computer, a notebook computer, a desktop computer, wearable device, internet of things device, a cell phone, a smart phone, a consumer appliance and/or instrumentation, an industrial and/or commercial device, a digital assistant, a multimedia Internet enabled phone, a multimedia players, and/or another type of device.

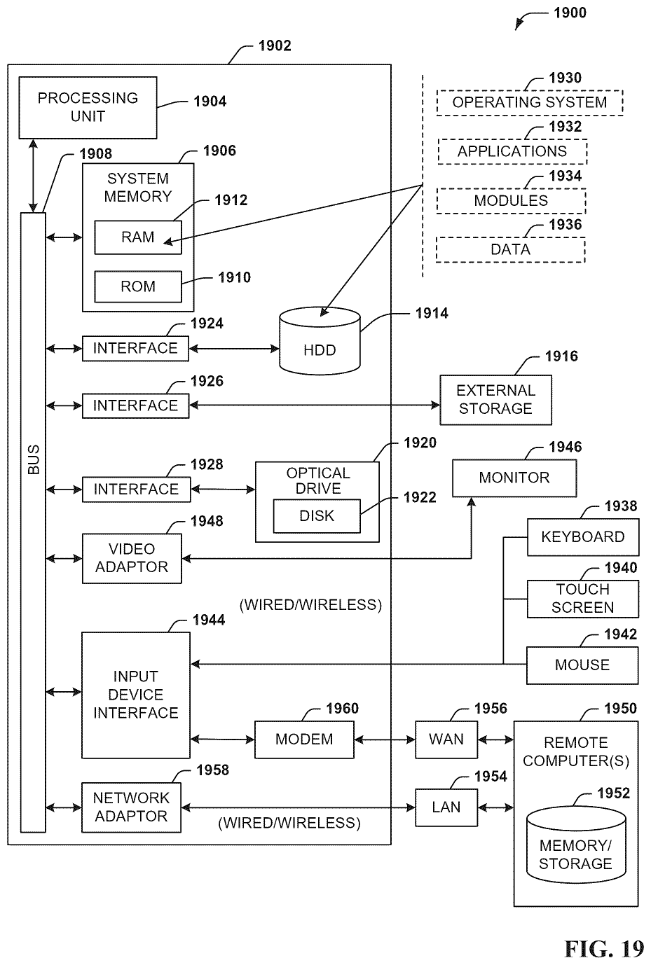

In order to provide additional context for various embodiments described herein, FIG. 19 and the following discussion are intended to provide a brief, general description of a suitable computing environment 1900 in which the various embodiments of the embodiment described herein can be implemented. While the embodiments have been described above in the general context of computer-executable instructions that can run on one or more computers, those skilled in the art will recognize that the embodiments can be also implemented in combination with other program modules and/or as a combination of hardware and software.

Generally, program modules include routines, programs, components, data structures, etc., that perform particular tasks or implement particular abstract data types. Moreover, those skilled in the art will appreciate that the various methods can be practiced with other computer system configurations, including single-processor or multiprocessor computer systems, minicomputers, mainframe computers, Internet of Things (IoT) devices, distributed computing systems, as well as personal computers (e.g., ruggedized personal computers), field-programmable gate arrays, hand-held computing devices, microprocessor-based or programmable consumer electronics, and the like, each of which can be operatively coupled to one or more associated devices.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media, machine-readable storage media, and/or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data, or unstructured data.

Computer-readable storage media can include, but are not limited to, random access memory (RAM), read only memory (ROM), electrically erasable programmable read only memory (EEPROM), flash memory or other memory technology, compact disk read only memory (CD ROM), digital versatile disk (DVD), Blu-ray disc (BD) or other optical disk storage, magnetic cassettes, magnetic tape, magnetic disk storage or other magnetic storage devices, solid state drives or other solid state storage devices, or other tangible and/or non-transitory media which can be used to store desired information. In this regard, the terms “tangible” or “non-transitory” herein as applied to storage, memory, or computer-readable media, are to be understood to exclude only propagating transitory signals per se as modifiers and do not relinquish rights to all standard storage, memory or computer-readable media that are not only propagating transitory signals per sc.

Computer-readable storage media can be accessed by one or more local or remote computing devices, e.g., via access requests, queries, or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic. RF, optic, infrared, and other wireless media.

With reference again to FIG. 19, the example environment 1900 for implementing various embodiments of the aspects described herein includes a computer 1902, the computer 1902 including a processing unit 1904, a system memory 1906 and a system bus 1908. The system bus 1908 couples system components including, but not limited to, the system memory 1906 to the processing unit 1904. The processing unit 1904 can be any of various commercially available processors, field-programmable gate array, AI accelerator application-specific integrated circuit, or other suitable processors. Dual microprocessors and other multi-processor architectures can also be employed as the processing unit 1904.

The system bus 1908 can be any of several types of bus structure that can further interconnect to a memory bus (with or without a memory controller), a peripheral bus, and a local bus using any of a variety of commercially available bus architectures. The system memory 1906 includes ROM 1910 and RAM 1912. A basic input/output system (BIOS) can be stored in a nonvolatile memory such as ROM, erasable programmable read only memory (EPROM), EEPROM, which BIOS contains the basic routines that help to transfer information between elements within the computer 1902, such as during startup. The RAM 1912 can also include a high-speed RAM such as static RAM for caching data. It is noted that unified Extensible Firmware Interface(s) can be utilized herein.

The computer 1902 further includes an internal hard disk drive (HDD) 1914 (e.g., EIDE, SATA), one or more external storage devices 1916 (e.g., a magnetic floppy disk drive (FDD) 1916, a memory stick or flash drive reader, a memory card reader, etc.) and an optical disk drive 1920 (e.g., which can read or write from a CD-ROM disc, a DVD, a BD, etc. (e.g., a disk 1922)). While the internal HDD 1914 is illustrated as located within the computer 1902, the internal HDD 1914 can also be configured for external use in a suitable chassis (not shown). Additionally, while not shown in environment 1900, a solid-state drive (SSD) could be used in addition to, or in place of, an HDD 1914. The HDD 1914, external storage device(s) 1916 and optical disk drive 1920 can be connected to the system bus 1908 by an HDD interface 1924, an external storage interface 1926 and an optical drive interface 1928, respectively. The interface 1924 for external drive implementations can include at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 1902, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer-executable instructions for performing the methods described herein.

A number of program modules can be stored in the drives and RAM 1912, including an operating system 1930, one or more application programs 1932, other program modules 1934 and program data 1936. All or portions of the operating system, applications, modules, and/or data can also be cached in the RAM 1912. The systems and methods described herein can be implemented utilizing various commercially available operating systems or combinations of operating systems.

Computer 1902 can optionally comprise emulation technologies. For example, a hypervisor (not shown) or other intermediary can emulate a hardware environment for operating system 1930, and the emulated hardware can optionally be different from the hardware illustrated in FIG. 19. In such an embodiment, operating system 1930 can comprise one virtual machine (VM) of multiple VMs hosted at computer 1902. Furthermore, operating system 1930 can provide runtime environments, such as the Java runtime environment or the .NET framework, for applications 1932. Runtime environments are consistent execution environments that allow applications 1932 to run on any operating system that includes the runtime environment. Similarly, operating system 1930 can support containers, and applications 1932 can be in the form of containers, which are lightweight, standalone, executable packages of software that include, e.g., code, runtime, system tools, system libraries and settings for an application.

Further, computer 1902 can be enabled with a security module, such as a trusted processing module (TPM). For instance, with a TPM, boot components hash next in time boot components, and wait for a match of results to secured values, before loading a next boot component. This process can take place at any layer in the code execution stack of computer 1902, e.g., applied at the application execution level or at the operating system (OS) kernel level, thereby enabling security at any level of code execution.

A user can enter commands and information into the computer 1902 through one or more wired/wireless input devices, e.g., a keyboard 1938, a touch screen 1940, and a pointing device, such as a mouse 1942. Other input devices (not shown) can include a microphone, an infrared (IR) remote control, a radio frequency (RF) remote control, or other remote control, a joystick, a virtual reality controller and/or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 1904 through an input device interface 1944 that can be coupled to the system bus 1908, but can be connected by other interfaces, such as a parallel port, an IEEE 1394 serial port, a game port, a USB port, an IR interface, a BLUETOOTH® interface, etc.

A monitor 1946 or other type of display device can be also connected to the system bus 1908 via an interface, such as a video adapter 1948. In addition to the monitor 1946, a computer typically includes other peripheral output devices (not shown), such as speakers, printers, etc.

The computer 1902 can operate in a networked environment using logical connections via wired and/or wireless communications to one or more remote computers, such as a remote computer(s) 1950. The remote computer(s) 1950 can be a workstation, a server computer, a router, a personal computer, portable computer, microprocessor-based entertainment appliance, a peer device or other common network node, and typically includes many or all of the elements described relative to the computer 1902, although, for purposes of brevity, only a memory/storage device 1952 is illustrated. The logical connections depicted include wired/wireless connectivity to a local area network (LAN) 1954 and/or larger networks, e.g., a wide area network (WAN) 1956. Such LAN and WAN networking environments are commonplace in offices and companies, and facilitate enterprise-wide computer networks, such as intranets, all of which can connect to a global communications network, e.g., the Internet.

When used in a LAN networking environment, the computer 1902 can be connected to the local network 1954 through a wired and/or wireless communication network interface or adapter 1958. The adapter 1958 can facilitate wired or wireless communication to the LAN 1954, which can also include a wireless access point (AP) disposed thereon for communicating with the adapter 1958 in a wireless mode.

When used in a WAN networking environment, the computer 1902 can include a modem 1960 or can be connected to a communications server on the WAN 1956 via other means for establishing communications over the WAN 1956, such as by way of the Internet. The modem 1960, which can be internal or external and a wired or wireless device, can be connected to the system bus 1908 via the input device interface 1944. In a networked environment, program modules depicted relative to the computer 1902 or portions thereof, can be stored in the remote memory/storage device 1952. It will be appreciated that the network connections shown are example and other means of establishing a communications link between the computers can be used.

When used in either a LAN or WAN networking environment, the computer 1902 can access cloud storage systems or other network-based storage systems in addition to, or in place of, external storage devices 1916 as described above. Generally, a connection between the computer 1902 and a cloud storage system can be established over a LAN 1954 or WAN 1956 e.g., by the adapter 1958 or modem 1960, respectively. Upon connecting the computer 1902 to an associated cloud storage system, the external storage interface 1926 can, with the aid of the adapter 1958 and/or modem 1960, manage storage provided by the cloud storage system as it would other types of external storage. For instance, the external storage interface 1926 can be configured to provide access to cloud storage sources as if those sources were physically connected to the computer 1902.

The computer 1902 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, store shelf, etc.), and telephone. This can include Wireless Fidelity (Wi-Fi) and BLUETOOTH® wireless technologies. Thus, the communication can be a predefined structure as with a conventional network or simply an ad hoc communication between at least two devices.

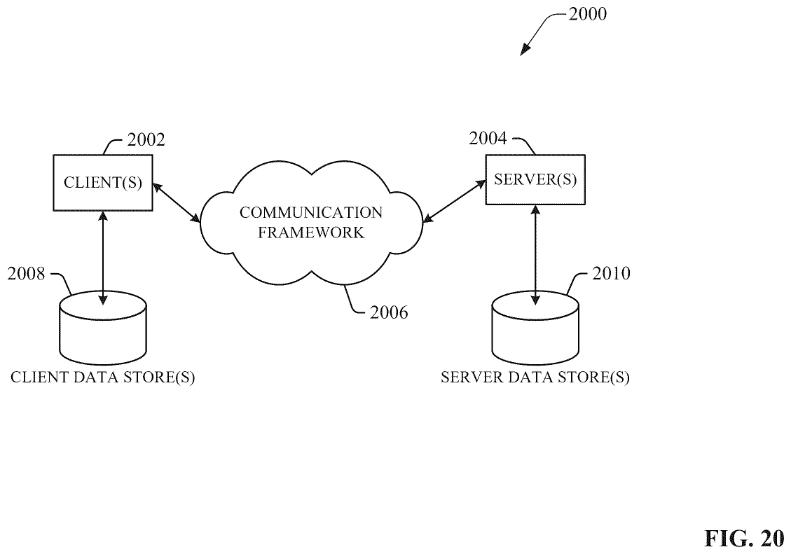

Referring now to FIG. 20, there is illustrated a schematic block diagram of a computing environment 2000 (e.g., a system) in accordance with this specification. The system 2000 includes one or more client(s) 2002, (e.g., computers, smart phones, tablets, cameras, PDA's). The client(s) 2002 can be hardware and/or software (e.g., threads, processes, computing devices). The client(s) 2002 can house cookie(s) and/or associated contextual information by employing the specification, for example.

The system 2000 also includes one or more server(s) 2004. The server(s) 2004 can also be hardware or hardware in combination with software (e.g., threads, processes, computing devices). The servers 2004 can house threads to perform transformations of media items by employing aspects of this disclosure, for example. One possible communication between a client 2002 and a server 2004 can be in the form of a data packet adapted to be transmitted between two or more computer processes wherein data packets may include coded analyzed headspaces and/or input. The data packet can include a cookie and/or associated contextual information, for example. The system 2000 includes a communication framework 2006 (e.g., a global communication network such as the Internet) that can be employed to facilitate communications between the client(s) 2002 and the server(s) 2004.

Communications can be facilitated via a wired (including optical fiber) and/or wireless technology. The client(s) 2002 are operatively connected to one or more client data store(s) 2008 that can be employed to store information local to the client(s) 2002 (e.g., cookie(s) and/or associated contextual information). Similarly, the server(s) 2004 are operatively connected to one or more server data store(s) 2010 that can be employed to store information local to the servers 2004. Further, the client(s) 2002 can be operatively connected to one or more server data store(s) 2010.

In one exemplary implementation, a client 2002 can transfer an encoded file, (e.g., encoded media item), to server 2004. Server 2004 can store the file, decode the file, or transmit the file to another client 2002. It is noted that a client 2002 can also transfer uncompressed file to a server 2004 and server 2004 can compress the file and/or transform the file in accordance with this disclosure. Likewise, server 2004 can encode information and transmit the information via communication framework 2006 to one or more clients 2002.

The illustrated aspects of the disclosure can also be practiced in distributed computing environments where certain tasks are performed by remote processing devices that are linked through a communications network. In a distributed computing environment, program modules can be located in both local and remote memory storage devices.

The above description includes non-limiting examples of the various embodiments. It is, of course, not possible to describe every conceivable combination of components or methods for purposes of describing the disclosed subject matter, and one skilled in the art can recognize that further combinations and permutations of the various embodiments are possible. The disclosed subject matter is intended to embrace all such alterations, modifications, and variations that fall within the spirit and scope of the appended claims.

With regard to the various functions performed by the above-described components, devices, circuits, systems, etc., the terms (including a reference to a “means”) used to describe such components are intended to also include, unless otherwise indicated, any structure(s) which performs the specified function of the described component (e.g., a functional equivalent), even if not structurally equivalent to the disclosed structure. In addition, while a particular feature of the disclosed subject matter may have been disclosed with respect to only one of several implementations, such feature can be combined with one or more other features of the other implementations as may be desired and advantageous for any given or particular application.

The terms “exemplary” and/or “demonstrative” as used herein are intended to mean serving as an example, instance, or illustration. For the avoidance of doubt, the subject matter disclosed herein is not limited by such examples. In addition, any aspect or design described herein as “exemplary” and/or “demonstrative” is not necessarily to be construed as preferred or advantageous over other aspects or designs, nor is it meant to preclude equivalent structures and techniques known to one skilled in the art. Furthermore, to the extent that the terms “includes,” “has,” “contains,” and other similar words are used in either the detailed description or the claims, such terms are intended to be inclusive-in a manner similar to the term “comprising” as an open transition word-without precluding any additional or other elements.

The term “or” as used herein is intended to mean an inclusive “or” rather than an exclusive “or.” For example, the phrase “A or B” is intended to include instances of A, B, and both A and B. Additionally, the articles “a” and “an” as used in this application and the appended claims should generally be construed to mean “one or more” unless either otherwise specified or clear from the context to be directed to a singular form.

The term “set” as employed herein excludes the empty set, i.e., the set with no elements therein. Thus, a “set” in the subject disclosure includes one or more elements or entities. Likewise, the term “group” as utilized herein refers to a collection of one or more entities.

The description of illustrated embodiments of the subject disclosure as provided herein, including what is described in the Abstract, is not intended to be exhaustive or to limit the disclosed embodiments to the precise forms disclosed. While specific embodiments and examples are described herein for illustrative purposes, various modifications are possible that are considered within the scope of such embodiments and examples, as one skilled in the art can recognize. In this regard, while the subject matter has been described herein in connection with various embodiments and corresponding drawings, where applicable, it is to be understood that other similar embodiments can be used or modifications and additions can be made to the described embodiments for performing the same, similar, alternative, or substitute function of the disclosed subject matter without deviating therefrom. Therefore, the disclosed subject matter should not be limited to any single embodiment described herein, but rather should be construed in breadth and scope in accordance with the appended claims below.

Further aspects of the invention are provided by the subject matter of the following clauses:

1. A system, comprising:
a memory that stores computer executable components; and
a processor that executes the computer executable components stored in the memory, wherein the computer executable components comprise:
a vehicular behavior component that, based upon a condition applicable to a second vehicle, other than a first vehicle, determines a predicted movement of the second vehicle; and
an overtake determination component that, based on the predicted movement being determined to satisfy a defined overtake condition, initiates an overtake action, applicable to the first vehicle, to overtake the second vehicle.

2. The system of any preceding clause, wherein the condition comprises a traffic condition applicable to the second vehicle, and wherein the computer executable components further comprise:
a traffic determination component that determines the traffic condition applicable to the second vehicle, wherein the predicted movement is determined based on the traffic condition.

3. The system of any preceding clause, wherein the condition comprises a type of the second vehicle, and wherein the computer executable components further comprise:
a vehicle determination component that determines the type of the second vehicle, wherein the predicted movement is determined based on the type of the second vehicle.

4. The system of any preceding clause, wherein the type of the second vehicle is a bus, and wherein the overtake action is based on a navigational rule applicable to the bus.

5. The system of any preceding clause, wherein the computer executable components further comprise:
a navigational rule component that, based on the type of the second vehicle, determines a navigational rule applicable to the second vehicle, wherein the overtake action is determined based on the navigational rule.

6. The system of any preceding clause, wherein the vehicle determination component determines a logo applicable to the second vehicle, wherein the predicted movement is determined based on the logo.

7. The system of any preceding clause, wherein the vehicle determination component determines a light applicable to the second vehicle, wherein the predicted movement is determined based on the light.

8. The system of any preceding clause, wherein the vehicle determination component determines a distance between the first vehicle and the second vehicle, wherein the defined overtake condition is based on the distance between the first vehicle and the second vehicle.

9. The system of any preceding clause, wherein the computer executable components further comprise:
a user determination component that determines a position of a user associated with the second vehicle, wherein the defined overtake condition is based on the position of the user.

10. The system of any preceding clause, wherein the user determination component determines a direction of navigation of the user, wherein the defined overtake condition is further based on the direction of navigation of the user.

11. The system of any preceding clause, wherein the user determination component determines entry or exit of the user from the second vehicle, wherein the defined overtake condition is further based on the entry or the exit of the user from the second vehicle.

12. The system of any preceding clause, wherein the computer executable components further comprise:
a timer component that determines an amount of time that the second vehicle remains stationary, wherein the defined overtake condition is based on the amount of time that the second vehicle remains stationary.

13. The system of any preceding clause, wherein the computer executable components further comprise:
a communication component that receives, from the second vehicle, navigation information representative of a future navigational operation applicable to the second vehicle, wherein the defined overtake condition is based on the future navigational operation.

14. The system of any preceding clause, wherein the computer executable components further comprise:
a machine learning component that, using machine learning applied to past overtake actions other than the overtake action and other vehicles other than the second vehicle, generates an overtake model, wherein the overtake determination component initiates the overtake action using the overtake model.

15. The system of clause 1 above with any set of combinations of the systems 2-14 above.

16. A non-transitory machine-readable medium, comprising executable instructions that, when executed by a processor, facilitate performance of operations, comprising:
based upon a condition applicable to a second vehicle, other than a first vehicle, determining a predicted movement of the second vehicle; and
based on the predicted movement being determined to satisfy a defined overtake condition, initiating an overtake action, applicable to the first vehicle, to overtake the second vehicle.

17. The non-transitory machine-readable medium of any preceding clause, wherein the predicted movement of the second vehicle is based on a type of road applicable to the second vehicle or the first vehicle.

18. The non-transitory machine-readable medium of any preceding clause, wherein the operations further comprise:
determining a color of the second vehicle, wherein the predicted movement is determined based on the color of the second vehicle.

19. The non-transitory machine-readable medium of clause 16 above with any set of combinations of the non-transitory machine-readable mediums 17-18 above.

20. A method, comprising:
based upon a condition applicable to a second vehicle, other than a first vehicle, determining, by a system comprising a processor, a predicted movement of the second vehicle; and
based on the predicted movement being determined to satisfy a defined overtake condition, initiating, by the system, an overtake action, applicable to the first vehicle, to overtake the second vehicle.

21. The method of any preceding clause, wherein the first vehicle comprises an autonomous vehicle.

22. The method of any preceding clause, further comprising:
determining a distance between the first vehicle and the second vehicle, wherein the defined overtake condition is based on the distance between the first vehicle and the second vehicle.

23. The method of clause 20 above with any set of combinations of the methods 21-22 above.

What is claimed is:

1. A system, comprising:
a memory that stores computer executable components; and
a processor that executes the computer executable components stored in the memory, wherein the computer executable components comprise:
a vehicular behavior component that, based upon a condition applicable to a second vehicle, other than a first vehicle, determines a predicted movement of the second vehicle; and
an overtake determination component that, based on the predicted movement being determined to satisfy a defined overtake condition, initiates an overtake action, applicable to the first vehicle, to overtake the second vehicle.

2. The system of claim 1, wherein the condition comprises a traffic condition applicable to the second vehicle, and wherein the computer executable components further comprise:
a traffic determination component that determines the traffic condition applicable to the second vehicle, wherein the predicted movement is determined based on the traffic condition.

3. The system of claim 1, wherein the condition comprises a type of the second vehicle, and wherein the computer executable components further comprise:
a vehicle determination component that determines the type of the second vehicle, wherein the predicted movement is determined based on the type of the second vehicle.

4. The system of claim 3, wherein the type of the second vehicle is a bus, and wherein the overtake action is based on a navigational rule applicable to the bus.

5. The system of claim 3, wherein the computer executable components further comprise:
a navigational rule component that, based on the type of the second vehicle, determines a navigational rule applicable to the second vehicle, wherein the overtake action is determined based on the navigational rule.

6. The system of claim 3, wherein the vehicle determination component determines a logo applicable to the second vehicle, wherein the predicted movement is determined based on the logo.

7. The system of claim 3, wherein the vehicle determination component determines a light applicable to the second vehicle, wherein the predicted movement is determined based on the light.

8. The system of claim 3, wherein the vehicle determination component determines a distance between the first vehicle and the second vehicle, wherein the defined overtake condition is based on the distance between the first vehicle and the second vehicle.

9. The system of claim 1, wherein the computer executable components further comprise:
a user determination component that determines a position of a user associated with the second vehicle, wherein the defined overtake condition is based on the position of the user.

10. The system of claim 9, wherein the user determination component determines a direction of navigation of the user, wherein the defined overtake condition is further based on the direction of navigation of the user.

11. The system of claim 9, wherein the user determination component determines entry or exit of the user from the second vehicle, wherein the defined overtake condition is further based on the entry or the exit of the user from the second vehicle.

12. The system of claim 1, wherein the computer executable components further comprise:
a timer component that determines an amount of time that the second vehicle remains stationary, wherein the defined overtake condition is based on the amount of time that the second vehicle remains stationary.

13. The system of claim 1, wherein the computer executable components further comprise:
a communication component that receives, from the second vehicle, navigation information representative of a future navigational operation applicable to the second vehicle, wherein the defined overtake condition is based on the future navigational operation.

14. The system of claim 1, wherein the computer executable components further comprise:
a machine learning component that, using machine learning applied to past overtake actions other than the overtake action and other vehicles other than the second vehicle, generates an overtake model, wherein the overtake determination component initiates the overtake action using the overtake model.

15. A non-transitory machine-readable medium, comprising executable instructions that, when executed by a processor, facilitate performance of operations, comprising:
based upon a condition applicable to a second vehicle, other than a first vehicle, determining a predicted movement of the second vehicle; and
based on the predicted movement being determined to satisfy a defined overtake condition, initiating an overtake action, applicable to the first vehicle, to overtake the second vehicle.

16. The non-transitory machine-readable medium of claim 15, wherein the predicted movement of the second vehicle is based on a type of road applicable to the second vehicle or the first vehicle.

17. The non-transitory machine-readable medium of claim 15, wherein the operations further comprise:
determining a color of the second vehicle, wherein the predicted movement is determined based on the color of the second vehicle.

18. A method, comprising:
based upon a condition applicable to a second vehicle, other than a first vehicle, determining, by a system comprising a processor, a predicted movement of the second vehicle; and
based on the predicted movement being determined to satisfy a defined overtake condition, initiating, by the system, an overtake action, applicable to the first vehicle, to overtake the second vehicle.

19. The method of claim 18, wherein the first vehicle comprises an autonomous vehicle.

20. The method of claim 18, further comprising:
determining a distance between the first vehicle and the second vehicle, wherein the defined overtake condition is based on the distance between the first vehicle and the second vehicle.
